(19) United States
(12) Patent Application Publication
(10) Pub. No.: US 2022/0215014 A1
(43) Pub. Date: Jul. 7, 2022

(54) SYSTEM REQUIREMENT EDITING DEVICE, SYSTEM REQUIREMENT EDITING METHOD, AND NON-TRANSITORY COMPUTER-READABLE MEDIUM

(71) Applicant: NEC Corporation, Tokyo (JP)

(72) Inventors: Takuya KUWAHARA, Tokyo (JP); Takayuki KURODA, Tokyo (JP)

(73) Assignee: NEC Corporation, Tokyo (JP)

(21) Appl. No.: 17/563,284

(22) Filed: Dec. 28, 2021

(30) Foreign Application Priority Data
Jan. 7, 2021 (JP) 2021-001575

(51) Int. Cl. G06F 16/23

(52) U.S. Cl. CPC G06F 16/2379

(57) ABSTRACT

A system requirement editing device according to the present disclosure includes: a requirement data management unit in which requirement data is registered, the requirement data being a graph representing system requirements; a view generation unit configured to input the requirement data, to input aspect models that are models defining a conversion method of converting the requirement data into a graph in which alternative representation of system requirements represented by the requirement data is given, to generate a view that is a graph obtained by converting the requirement data using the aspect models, and to output the generated view as a pre-update view; and a requirement data update unit configured to input the requirement data, to input a post-update view that is a view obtained after the pre-update view is updated, and to reflect a content of the post-update view on the requirement data.

### INCORPORATION BY REFERENCE

This application is based upon and claims the benefit of priority from Japanese patent application No. 2021-001575, filed on Jan. 7, 2021, the disclosure of which is incorporated herein in its entirety by reference.

### TECHNICAL FIELD

The present disclosure relates to a system requirement editing device, a system requirement editing method, and a non-transitory computer-readable medium.

### BACKGROUND ART

There is a technique for converting abstract system requirements representing a computer system configuration, an IoT (Internet of Things) system configuration, and an ICT (Information and Communication Technology) system configuration into concrete system configurations.

For example, a technique is disclosed in International Patent Publication No. WO 2019/216082 in which a designer edits system requirements represented in a graph formed by nodes corresponding to components of a system and edges defining a relation between two nodes, and a system configuration derivation device converts the system requirements edited by the designer into a concrete system configuration using a concretization rule.

As described above, according to the technique disclosed in International Patent Publication No. WO 2019/216082, the user (designer) edits the system requirements.

However, the system requirements edited by the user are system requirements represented in a graph formed by nodes and edges, and the nodes corresponding to all components included in the system requirements and the edges indicating functional dependency between the nodes are integrated into one graph.

Therefore, when the user edits large-scale system requirements or system requirements having a complicated structure through the original graphical representation, it becomes difficult for the user to recognize actual conditions of the system requirements, and thus editing mistakes and omission of consideration may be caused in the system requirements.

### SUMMARY

Therefore, the present disclosure is to solve the above-described problem, and to provide a system requirement editing device, a system requirement editing method, and a non-transitory computer-readable medium in which a user can easily edit system requirements.

An aspect of the present disclosure provides a system requirement editing device according to one aspect including:
a requirement data management unit in which requirement data is registered, the requirement data being a graph representing system requirements;
a view generation unit configured to input the requirement data, to input aspect models that are models defining a conversion method of converting the requirement data into a graph in which alternative representation of system requirements represented by the requirement data is given, to generate a view that is a graph obtained by converting the requirement data using the aspect models, and to output the generated view as a pre-update view; and
a requirement data update unit configured to input the requirement data, to input a post-update view that is a view obtained after the pre-update view is updated, and to reflect a content of the post-update view on the requirement data.

Another aspect of the present disclosure provides a system requirement editing method performed by the system requirement editing device, the method including:
a step of registering requirement data that is a graph representing system requirements;
a step of inputting the requirement data, inputting aspect models that are models defining a conversion method of converting the requirement data into a graph in which alternative representation of system requirements represented by the requirement data is given, generating a view that is a graph obtained by converting the requirement data using the aspect models, and outputting the generated view as a pre-update view; and
a step of inputting the requirement data, inputting a post-update view that is a view obtained after the pre-update view is updated, and reflecting a content of the post-update view on the requirement data.

Still another aspect of the present disclosure provides a non-transitory computer-readable medium in which a program is stored, the program causing a computer to execute:
a procedure of registering requirement data that is a graph representing system requirements;
a procedure of inputting the requirement data, inputting aspect models that are models defining a conversion method of converting the requirement data into a graph in which alternative representation of system requirements represented by the requirement data is given, generating a view that is a graph obtained by converting the requirement data using the aspect models, and outputting the generated view as a pre-update view; and
a procedure of inputting the requirement data, inputting a post-update view that is a view obtained after the pre-update view is updated, and reflecting a content of the post-update view on the requirement data.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a configuration example of a system requirement editing device according to a first example embodiment;

FIG. 2 is a view showing an example of a user interface of the system requirement editing device according to the first example embodiment;

FIG. 3 is a flowchart illustrating an example of a flow of a schematic operation of the system requirement editing device according to the first example embodiment;

FIG. 4 is a view illustrating an example of node conversion mapping;

FIG. 5 is a view illustrating an example of edge conversion mapping;

FIG. 6 is a view illustrating an example of a property of the node conversion mapping;

FIG. 7 is a flowchart illustrating an example of a flow of an operation during reading of an aspect model;

FIG. 8 is a view illustrating an example of an abstract type stub(t) corresponding to a generation type t of the node conversion mapping;

FIG. 9 is a view illustrating an example of an abstract type stub(t) corresponding to a generation type t of the edge conversion mapping;

FIG. 10 is a view illustrating a special example of an abstract type stub(t);

FIG. 11 is a view illustrating a special example of an abstract type stub(t);

FIG. 12 is a view illustrating an example of a structure generation pattern corresponding to the node conversion mapping;

FIG. 13 is a view illustrating an example of a structure generation pattern corresponding to the edge conversion mapping;

FIG. 14 is a view illustrating an example of dealing with property mapping information possessed by the node conversion mapping;

FIG. 15 is a view illustrating an example of node conversion mapping and an abstract type stub(t) corresponding to a generation type t of the node conversion mapping;

FIG. 16 is a view illustrating an example of a combination of node conversion mapping, an abstract type stub(t) corresponding to a generation type t of the node conversion mapping, and a structure generation pattern corresponding to the node conversion mapping;

FIG. 17 is a view illustrating an example of a combination of edge conversion mapping, an abstract type stub(t) corresponding to a generation type t of the edge conversion mapping, and a structure generation pattern corresponding to the edge conversion mapping;

FIG. 18 is a flowchart illustrating an example of a flow of forward conversion by a view generation unit according to the first example embodiment;

FIG. 19 is a flowchart illustrating an example of a flow of forward conversion by the view generation unit according to the first example embodiment;

FIG. 20 is a view illustrating a concrete example of operations of steps S301 and S302 shown in FIG. 18;

FIG. 21 is a view illustrating a concrete example of operations of steps S303 to S306 shown in FIG. 18;

FIG. 22 is a view illustrating a concrete example of operations of steps S304 to S306 shown in FIG. 18;

FIG. 23 is a view illustrating a concrete example of operations of steps S308 to S311 shown in FIG. 19;

FIG. 24 is a view illustrating a concrete example of operations of steps S308 to S311 shown in FIG. 19;

FIG. 25 is a view illustrating an example of a view and a mapping table after the forward conversion operation shown in FIGS. 18 and 19 is completed;

FIG. 26 is a flowchart illustrating an example of a flow of a backward conversion operation by a requirement data update unit according to the first example embodiment;

FIG. 27 is a flowchart illustrating an example of a flow of the backward conversion operation by the requirement data update unit according to the first example embodiment;

FIG. 28 is a view illustrating a concrete example of an operation of step S401 shown in FIG. 26;

FIG. 29 is a view illustrating a concrete example of an operation of step S402 shown in FIG. 26;

FIG. 30 is a view illustrating a concrete example of an operation of step S403 shown in FIG. 26;

FIG. 31 is a view illustrating a concrete example of operations of steps S404 and S405 shown in FIG. 26;

FIG. 32 is a view illustrating a concrete example of operations of steps S404 and S405 shown in FIG. 26;

FIG. 33 is a view illustrating a concrete example of operations of steps S407 and S408 shown in FIG. 27;

FIG. 34 is a view illustrating a concrete example of operations of steps S407, S408, and S410 shown in FIG. 27;

FIG. 35 is a view illustrating a concrete example of an operation of step S410 shown in FIG. 27;

FIG. 36 is a view illustrating a concrete example of an operation of step S411 shown in FIG. 27;

FIG. 37 is a view illustrating a concrete example of an operation of step S411 shown in FIG. 27;

FIG. 38 is a block diagram showing a configuration example of a system requirement editing device according to a second example embodiment; and

FIG. 39 is a block diagram showing a hardware configuration example of a system requirement editing device according to a third example embodiment.

### EMBODIMENTS

Example embodiments according to the present disclosure will be described hereinafter with reference to the drawings. Note that the following description and the drawings are omitted and simplified as appropriate for clarifying the description. Further, in each of the following drawings, the same components are designated by the same reference numerals, and are not described repeatedly as necessary.

### First Example Embodiment

### <Configuration of First Example Embodiment>

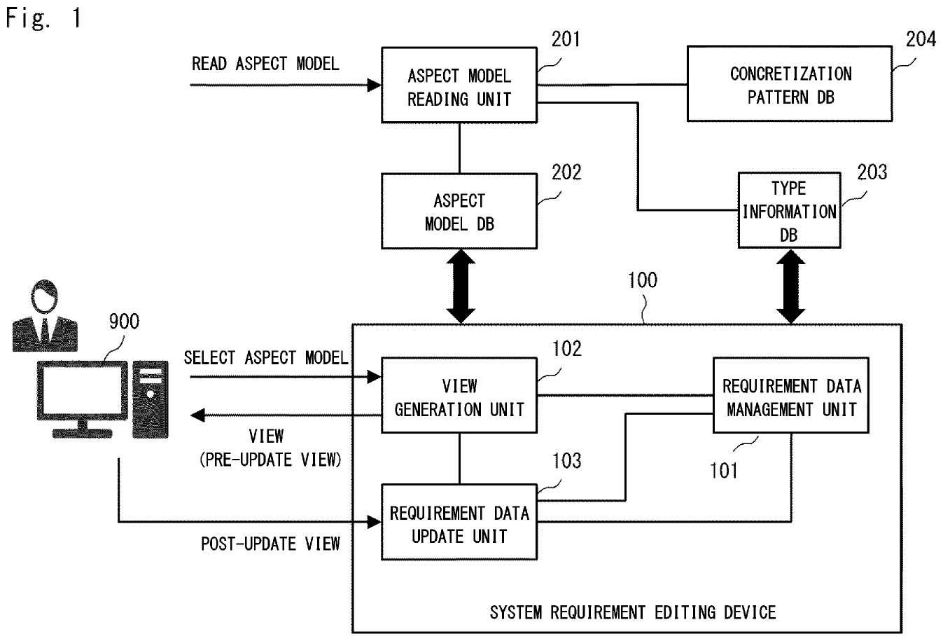

First, a configuration of a system requirement editing device 100 according to a first example embodiment will be described with reference to FIG. 1. As shown in FIG. 1, the system requirement editing device 100 according to the first example embodiment includes a requirement data management unit 101, a view generation unit 102, and a requirement data update unit 103. Outside the system requirement editing device 100 according to the first example embodiment, an aspect model reading unit 201, an aspect model DB (Data Base) 202, a type information DB 203, and a concretization pattern DB 204 are provided.

Requirement data is registered in the requirement data management unit 101. The requirement data is a graph representing system requirements, and is configured by an entity including nodes corresponding to components of the system and an edge defining a relation between two nodes.

The view generation unit 102 inputs the requirement data from the requirement data management unit 101, and also input an aspect model from the aspect model DB 202. The aspect model is a model that defines a conversion method of converting the requirement data into a graph in which alternative representation of the system requirements represented by the requirement data is given. In other words, the aspect model is a model that defines a conversion method of converting a substructure in the requirement data into an entity. The view generation unit 102 displays a list of aspect models to a user who uses a terminal 900 using, for example, a user interface (to be described below), causes the user to select a desired aspect model from a plurality of aspect models displayed in the list, and inputs the desired aspect model (hereinafter, referred to as “selected aspect model”) selected by the user from the aspect model DB 202.

Further, the view generation unit 102 generates a view from the requirement data using the selected aspect model. The view is a graph obtained by converting the requirement data using the selected aspect model. In addition, the view generation unit 102 outputs, as a pre-update view, the generated view to the terminal 900.

The requirement data update unit 103 inputs the requirement data from the requirement data management unit 101, and also inputs a post-update view obtained after the pre-update view is updated by the user, from the terminal 900. Then, the requirement data update unit 103 reflects the content of the post-update view on the requirement data. In other words, the requirement data update unit 103 converts the post-update view into requirement data.

### <User Interface of First Example Embodiment>

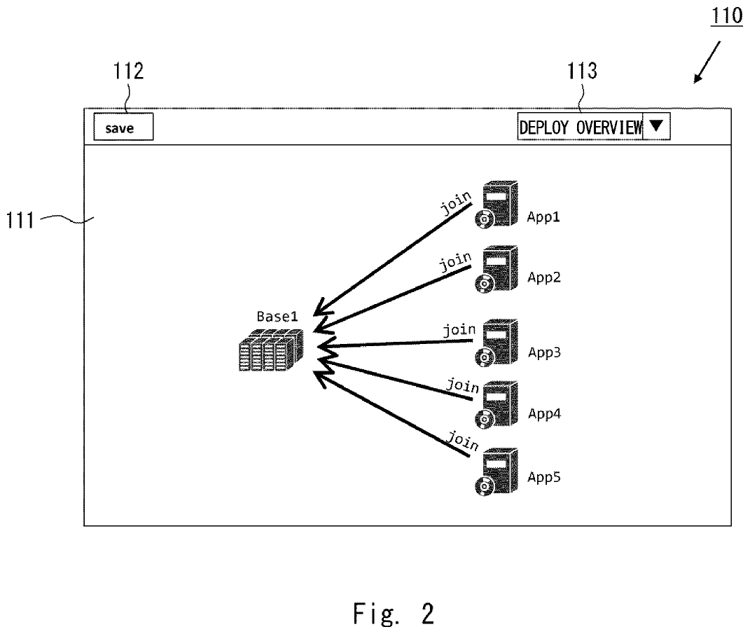

Subsequently, an example of a user interface 110 of the system requirement editing device 100 according to the first example embodiment will be described with reference to FIG. 2. The user interface 110 shown in FIG. 2 is used to exchange information or data between the system requirement editing device 100 and the terminal 900, and includes a requirement editing screen 111, an edit content save button 112, and an aspect model selection interface 113.

On the aspect model selection interface 113, a list of aspect models is displayed in a drop-down manner, for example. The user can select the aspect model to be used from the aspect models displayed in the list. When the aspect model is selected by the user, the view generation unit 102 generates a view from the requirement data using the selected aspect model. The generated view is displayed on the requirement editing screen 111 as a pre-update view.

On the requirement editing screen 111, the user can browse the pre-update view and edit the pre-update view at the same time. Specifically, the user can add and delete nodes/edges as editing of the pre-update view, and can edit properties associated with the nodes/edges at the same time.

The edit content save button 112 is a button (software button) used to save the edit content edited on the requirement editing screen 111. The user clicks the edit content save button 112 when the editing of the pre-update view is completed. Then, the requirement data update unit 103 inputs the view, which is edited by the user, as a post-update view, and reflects the content of the post-update view on the requirement data.

### <Schematic Operation of First Example Embodiment>

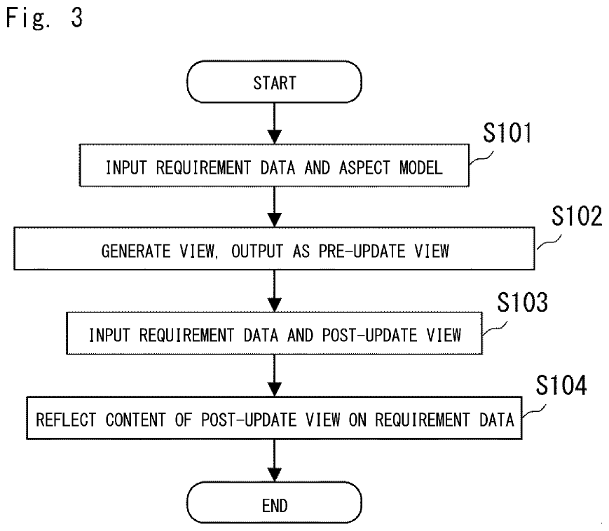

Subsequently, a description will be given with reference to FIG. 3 with respect to a flow of a schematic operation of the system requirement editing device 100 according to the first example embodiment.

As shown in FIG. 3, first, the view generation unit 102 inputs the requirement data from the requirement data management unit 101, and inputs the desired aspect model (that is, the “selected aspect model” described above), which is selected by the user, from the aspect model DB 202 at the same time (step S101).

Next, the view generation unit 102 generates a view obtained by converting the requirement data using the selected aspect model, and outputs the generated view as a pre-update view to the terminal 900 (step S102).

The requirement data update unit 103 inputs the requirement data from the requirement data management unit 101, and inputs the post-update view obtained after the pre-update view is updated by the user, from the terminal 900 at the same time (step S103).

Thereafter, the requirement data update unit 103 reflects the content of the post-update view on the requirement data (step S104).

Hereinafter, the system requirement editing device 100 according to the first example embodiment will be described in detail.

### <Aspect Model>

First, a plurality of aspect models prepared in advance in the aspect model DB 202 will be described.

As described above, the aspect model is a model that defines a conversion method of converting the requirement data into a graph in which alternative representation of the system requirements represented by the requirement data is given. In other words, the aspect model is a model that indicates information on how to convert and display the requirement data.

The aspect model is manually generated according to the purpose such as “application deployment”, “NW (Network) continuity”, and “inter-service cooperation”, and is registered in advance in the aspect model DB 202. The aspect model may be customized as necessary even after being registered in the aspect model DB 202.

The aspect model (that is, the “selected aspect model” described above) referenced for view generation is selected by the user. At this time, the view generation unit 102 may display the list of the plurality of aspect models registered in the aspect model DB 202, using the user interface 110 as shown in FIG. 2, and may cause the user to select the aspect model (selected aspect model) from the aspect models displayed in the list. The aspect model selected by the user is given as an input to the view generation unit 102 from the aspect model DB 202.

Among the plurality of aspect models, any aspect model includes node conversion mapping and edge conversion mapping. Both the node conversion mapping and the edge conversion mapping are to convert a substructure in the requirement data into an entity that is a node or an edge.

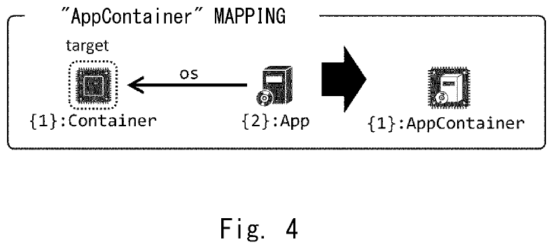

The node conversion mapping is to convert the substructure in the requirement data into a node. An example of “AppContainer” mapping, which is an example of the node conversion mapping, will be described with reference to FIG. 4. In the example of FIG. 4, a substructure (hereinafter, referred to as a conversion structure as appropriate) on a left side of an arrow in the requirement data is converted into a node “AppContainer” by “AppContainer” mapping. Note that the node conversion mapping is performed under a condition that only one node is designated as a “target”. In addition, one node having the same ID (Identity) as “target” is generated by the node conversion mapping.

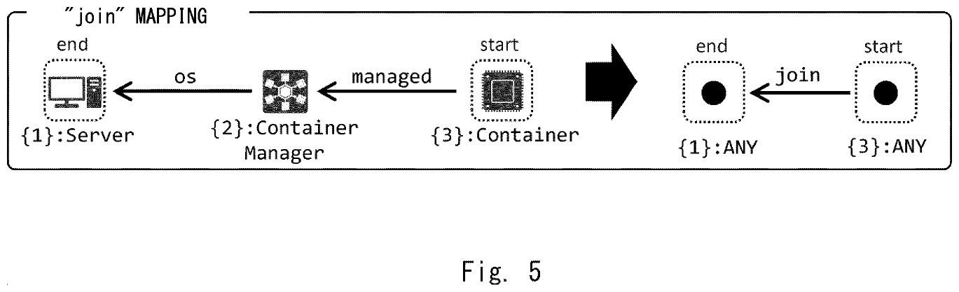

In addition, the edge conversion mapping is to convert a substructure in the requirement data into an edge. An example of “join” mapping, which is an example of the edge conversion mapping, will be described with reference to FIG. 5. In the example of FIG. 5, a conversion structure on the left side of the arrow contained in the requirement data is converted into an edge

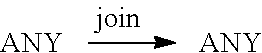

by “join” mapping. The edge conversion mapping is performed under a condition that one node is specified by “start” and one node is specified by “end”. Further, the edge conversion mapping causes the edge to spread from the node specified by “start” to the node specified by “end”.

Thereafter, a type generated as a result of mapping is referred to as a mapping generation type. In the example of FIG. 4, the node “AppContainer” is a generation type, and the edge

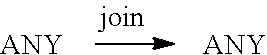

is a generation type in the example of FIG. 5. These generation types will be added to the view as entities.

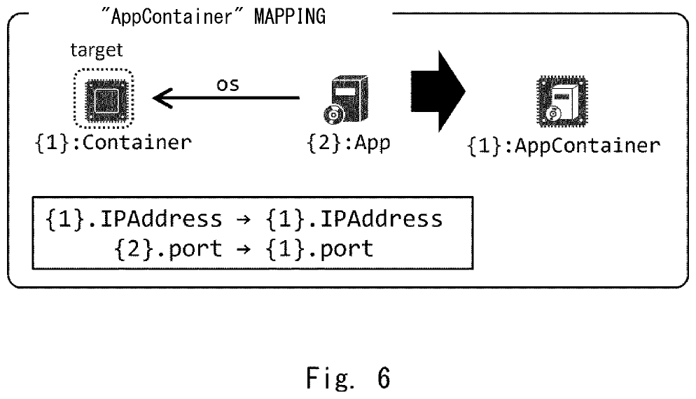

In addition, the mapping can have property mapping information indicating a correspondence relation between a property associated with the entity in the requirement data and a property associated with the entity in the view. An example of a property of the “AppContainer” mapping will be described with reference to FIG. 6. A property associated with an entity on a left side of an arrow in the requirement data corresponds to a property associated with an entity on a right side of an arrow in the view one-to-one. In the example of FIG. 6, a property “IPAddress” of a node “Container” on the left side of the arrow corresponds one-to-one to a property “IPAddress” of a node “AppContainer” on the right side of the arrow. In addition, a property “port” of a node “App” on the left side of the arrow corresponds one-to-one to a property “port” of the node “AppContainer” on the right side of the arrow.

<Operation during Reading of Aspect Model>

Subsequently, an operation during reading of the aspect model will be described.

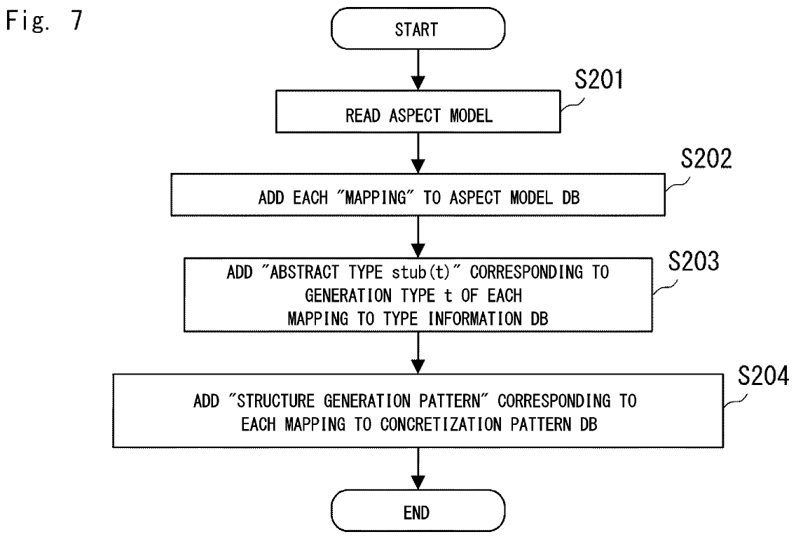

First, an example of a flow of the operation during reading of the aspect model will be described with reference to FIG. 7.

As shown in FIG. 7, first, the aspect model reading unit 201 reads the aspect model which is manually generated (step S201), and adds each of the node conversion mapping and the edge conversion mapping included in the read aspect model to the aspect model DB 202 (step S202).

Next, the aspect model reading unit 201 adds an “abstract type stub(t)” corresponding to a generation type t of each mapping to the type information DB 203 (step S203).

Thereafter, the aspect model reading unit 201 adds a “structure generation pattern” corresponding to each mapping to the concretization pattern DB 204 (step S204). For the “structure generation pattern”, a system configuration derivation device (not shown) is used. Specifically, the system configuration derivation device (not shown) converts the system requirements edited by the system requirement editing device 100 into a concrete system configuration using the “structure generation pattern”.

Subsequently, the “abstract type stub(t)” added to the type information DB 203 will be described.

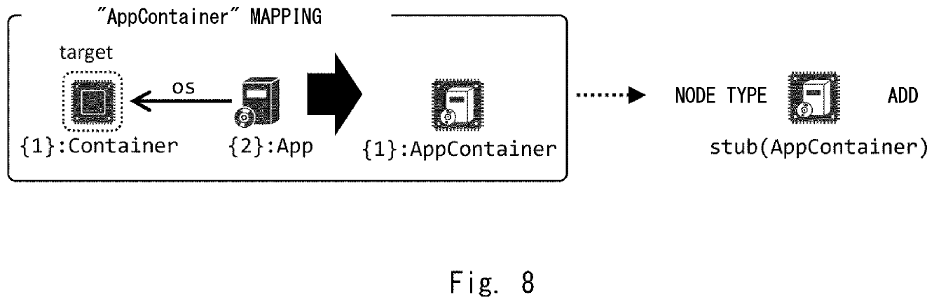

First, an example of an “abstract type stub(t)” corresponding to a generation type t of “AppContainer” mapping will be described with reference to FIG. 8. In the example of FIG. 8, the generation type t of the “AppContainer” mapping is a node “AppContainer”. The abstract type stub(t) corresponding to the generation type t is an abstract type stub(AppContainer) of a node type.

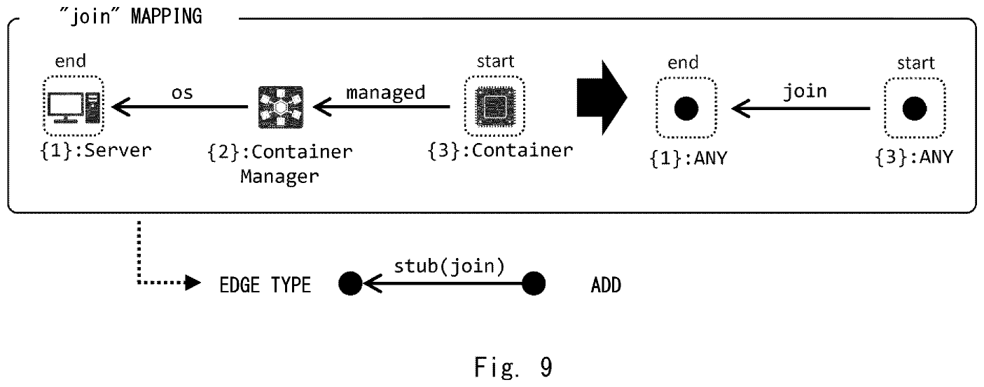

Next, an example of an “abstract type stub(t)” corresponding to a generation type t of “join” mapping will be described with reference to FIG. 9. In the example of FIG. 9, the generation type t of the “join” mapping is an edge

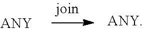

An abstract type stub(t) corresponding to the generation type t is an abstract type stub(join) of an edge type.

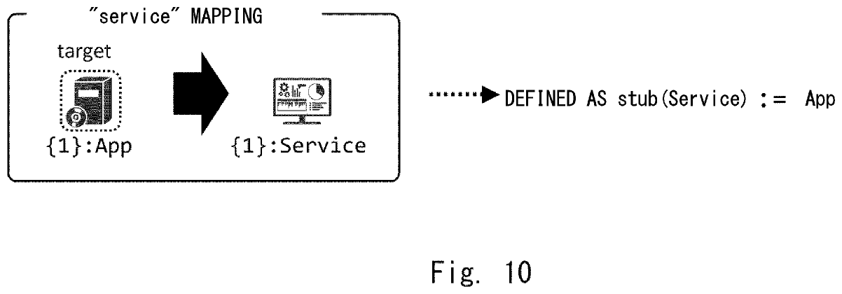

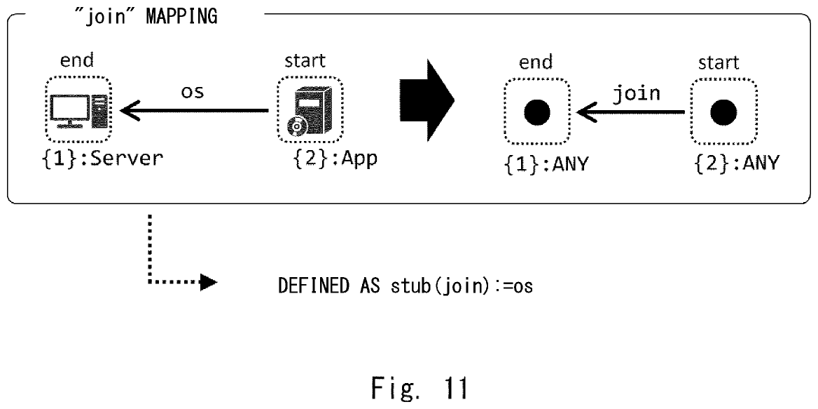

Subsequently, a special example of the “abstract type stub(t)” will be described with reference to FIGS. 10 and 11.

The “AppContainer” mapping in FIG. 4 and the “join” mapping in FIG. 5 are not one-to-one mappings in which entities before and after the conversion correspond one-to-one to each other.

On the other hand, “Service” mapping in FIG. 10 and “join” mapping in FIG. 11 are one-to-one mappings.

In the case of one-to-one mapping, the aspect model reading unit 201 does not add the abstract type stub(t) to the type information DB 203, but may define the abstract type stub(t) as a “stub(t):=t_{orig}” using a corresponding original generation type t_{orig}. The abstract type stub(t) is defined as stub(Service):=App in the example of FIG. 10, and is defined as stub(join):=os in the example of FIG. 11. In this case, the aspect model reading unit 201 does not perform an operation of adding the “stub(t):=t_{orig}” to the type information DB 203. However, when another mapping is defined for the same generation type, the aspect model reading unit 201 cannot make the above definition.

Subsequently, the “structure generation pattern” added to the concretization pattern DB 204 will be described.

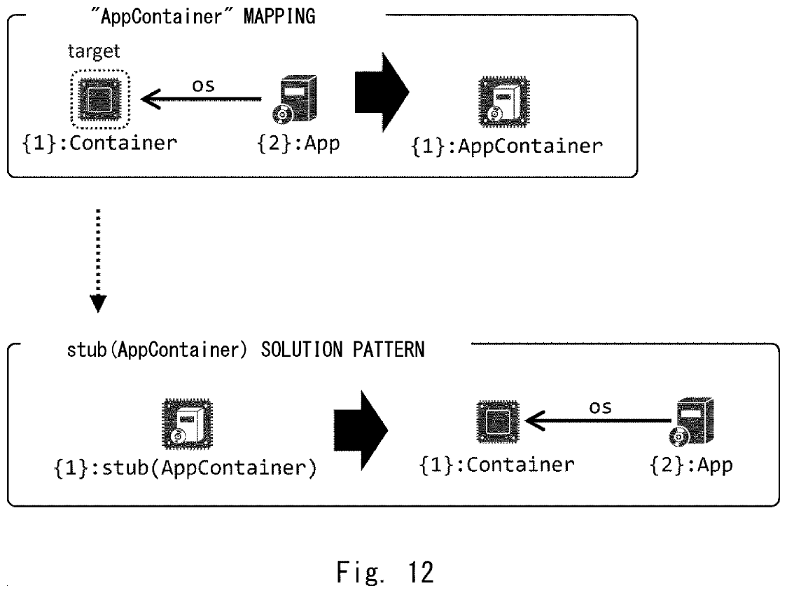

First, an example of a structure generation pattern corresponding to “AppContainer” mapping will be described with reference to FIG. 12. As shown in FIG. 12, the structure generation pattern is a stub(AppContainer) solution pattern corresponding to a pattern in which a conversion direction of the “AppContainer” mapping is reversed.

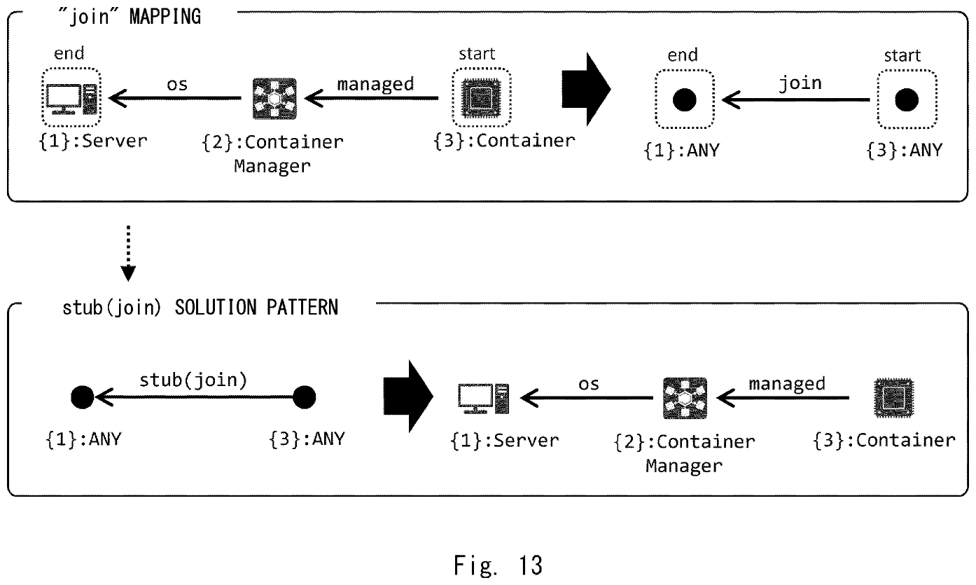

Next, an example of a structure generation pattern corresponding to “join” mapping will be described with reference to FIG. 13. As shown in FIG. 13, the structure generation pattern is a stub(join) solution pattern corresponding to a pattern in which a conversion direction of the “join” mapping is reversed.

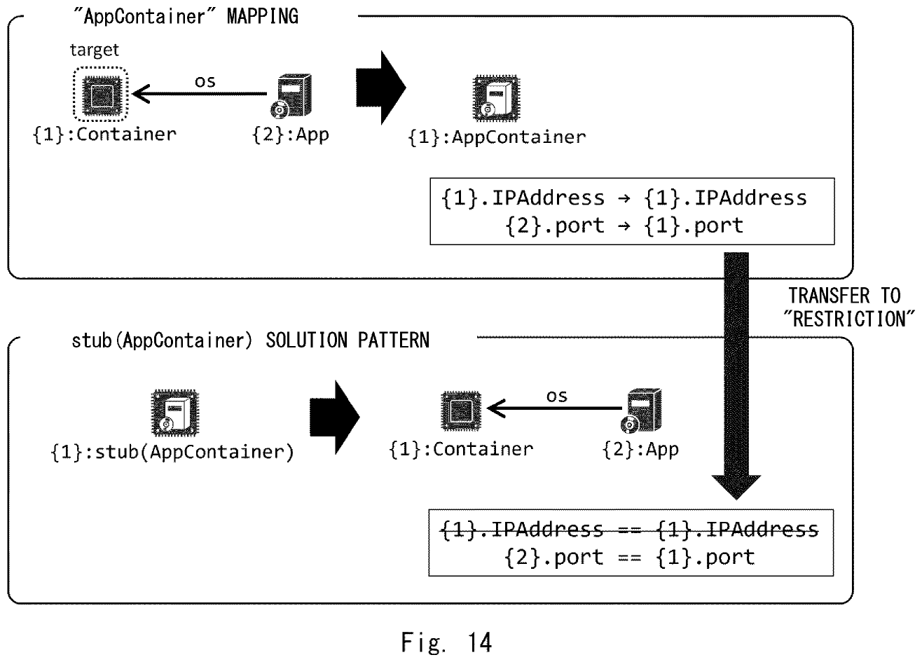

Subsequently, an example of dealing with property mapping information possessed by the mapping will be described with reference to FIG. 14. In the example of FIG. 14, “AppContainer” mapping has the property mapping information shown in FIG. 6. A structure generation pattern corresponding to the “AppContainer” mapping is the same pattern as the stub(AppContainer) solution pattern shown in FIG. 12. Therefore, the aspect model reading unit 201 transfers the property mapping information of the “AppContainer” mapping to a “restriction” of a stub(AppContainer) solution pattern. At this time, the aspect model reading unit 201 converts an arrow (→) representing the mapping into an equal sign (==). Further, the aspect model reading unit 201 eliminates meaningless restrictions. In the example of FIG. 14, a restriction called “{1}.IPAddress=={1}.IPAddress” is eliminated.

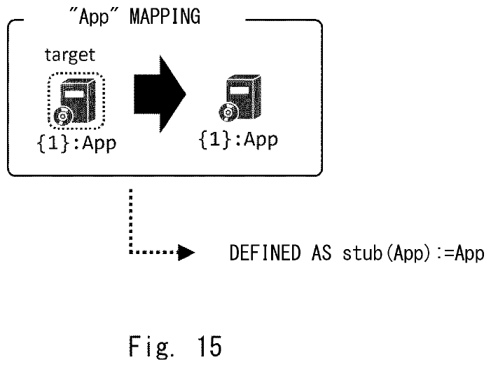

Subsequently, a description will be given with reference to FIGS. 15 to 17 with respect to an example of a combination of mapping, an “abstract type stub(t)” corresponding to a generation type t of the mapping, and a “structure generation pattern” corresponding to the mapping.

FIG. 15 shows an example of one-to-one mapping. In the example of FIG. 15, “App” mapping is one-to-one mapping. Therefore, the aspect model reading unit 201 defines “stub(App):=App”, but does not add the “stub(App):=App” to the type information DB 203, as an abstract type stub(t). In addition, since the aspect model reading unit 201 does not add the abstract type stub(t), the aspect model reading unit 201 does not also add a structure generation pattern to the concretization pattern DB 204.

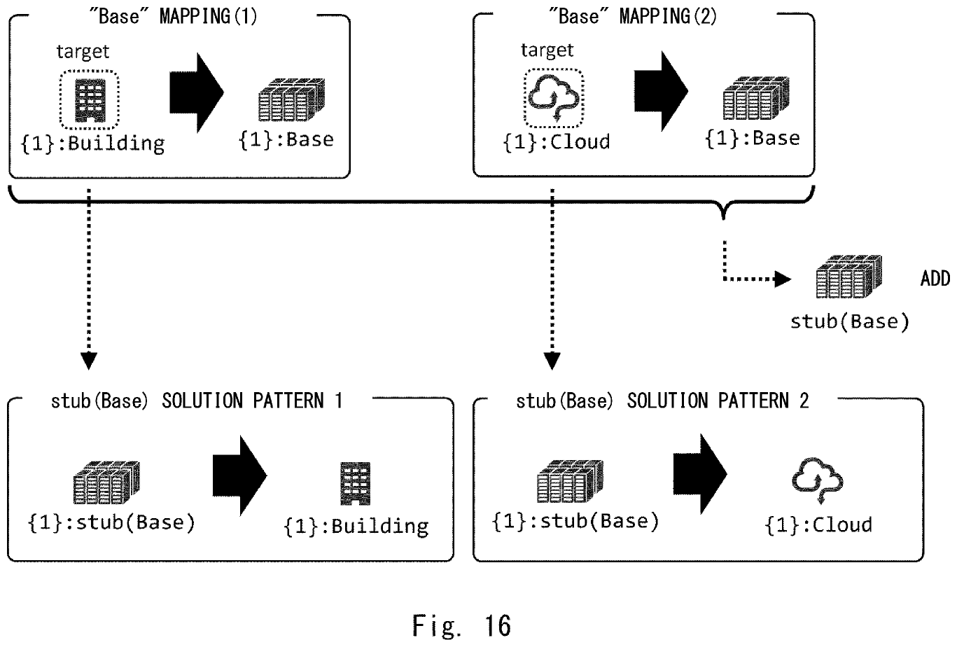

FIG. 16 shows an example in which a plurality of mappings exist in one generation type. In the example of FIG. 16, two mappings of “Base” mapping(1) and “Base” mapping(2) exist in a node “Base” which is a generation type. Therefore, the aspect model reading unit 201 adds an abstract type stub(Base) corresponding to the node “Base” to the type information DB 203. In addition, the aspect model reading unit 201 adds a stub(Base) solution pattern 1 corresponding to the “Base” mapping(1) and a stub(Base) solution pattern 2 corresponding to the “Base” mapping(2) to the concretization pattern DB 204, as structure generation patterns, respectively.

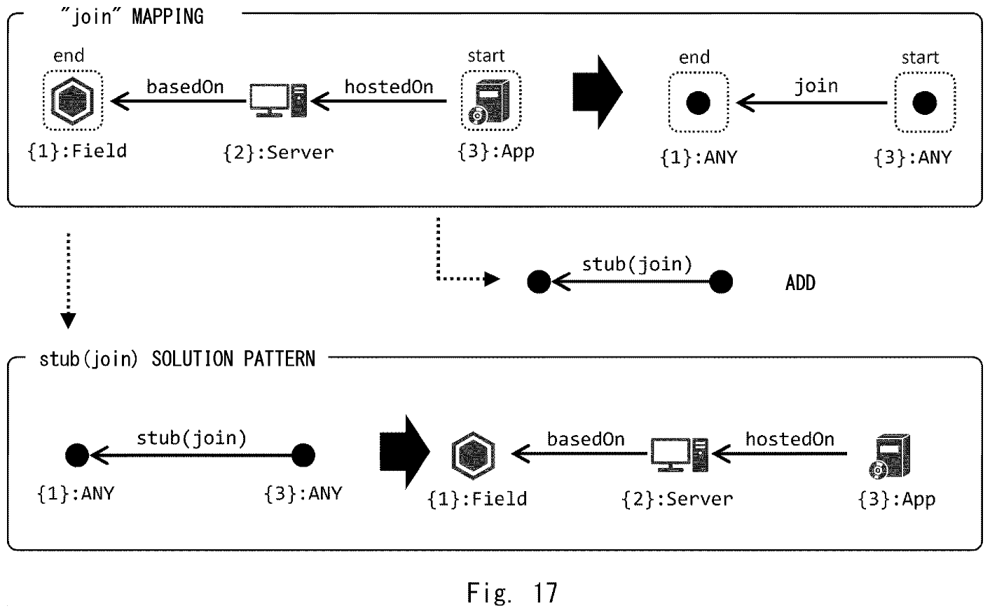

FIG. 17 shows an example of mapping including a node corresponding to a parent class of any node. In the example of FIG. 16, a node “Field” included in “join” mapping corresponds to a parent class of a node “Building” and a node “Cloud”. The aspect model reading unit 201 adds an abstract type stub(join) corresponding to a generation type of the “join” mapping to the type information DB 203. In addition, the aspect model reading unit 201 adds a stub(join) solution pattern corresponding to the “join” mapping to the concretization pattern DB 204, as a structure generation pattern.

### <Forward Conversion>

Subsequently, a description will be given with respect to a conversion operation in which the view generation unit 102 converts the requirement data into a view (pre-update view). Hereinafter, such a conversion is appropriately referred to as a forward conversion.

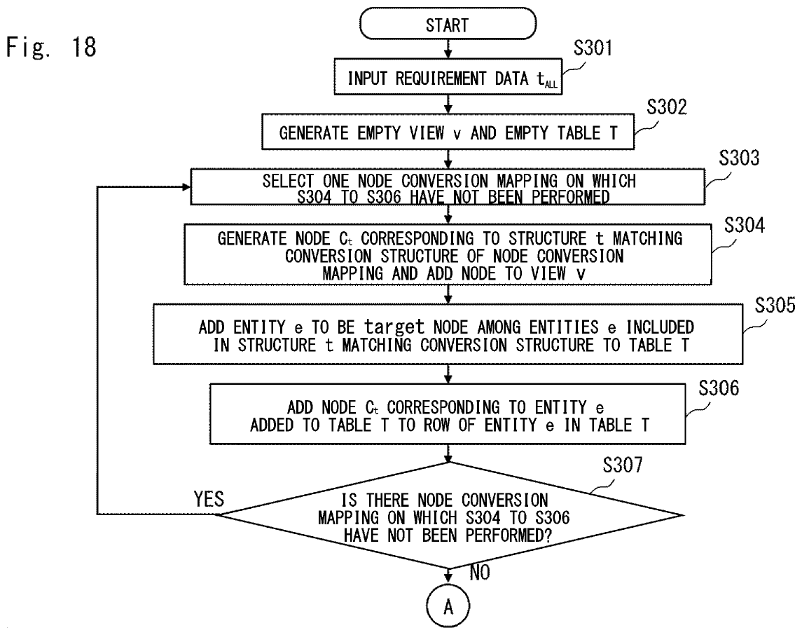

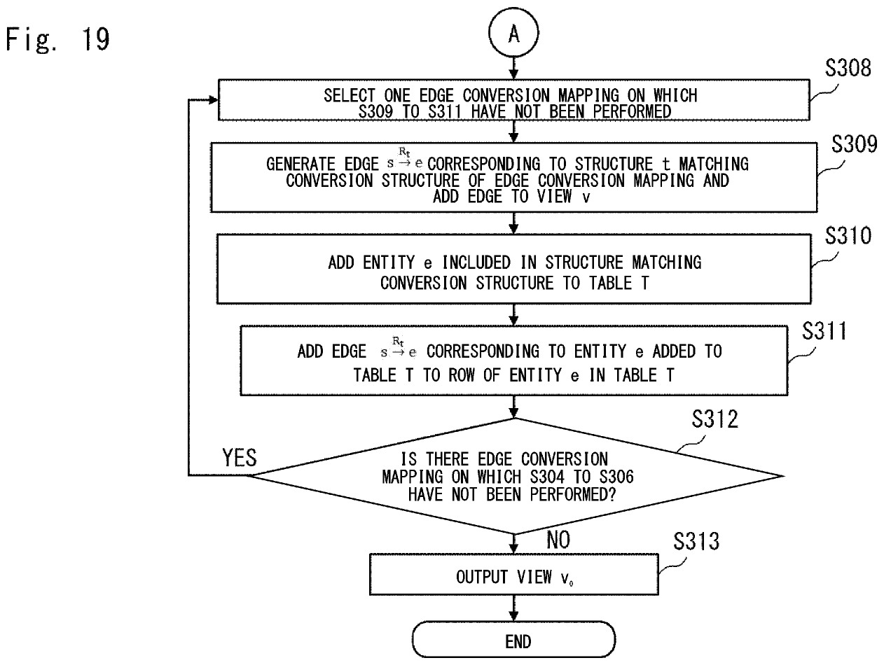

First, a description will be given with reference to FIGS. 18 and 19 with respect to an example of a flow of the forward conversion operation by the view generation unit 102. Here, it is assumed that the aspect model has already been selected by a user.

As shown in FIGS. 18 and 19, first, the view generation unit 102 inputs requirement data t_{ALL} from the requirement data management unit 101 (step S301).

Next, the view generation unit 102 generates an empty view v and an empty mapping table T (step S302). The mapping table T is a table that entities in the requirement data t_{ALL} are shown in a mapping source column and entities in a view corresponding to the entities in the requirement data t_{ALL} are shown in the mapping destination column in the same row.

Next, the view generation unit 102 selects one node conversion mapping, on which the following steps S304 to S306 have not been performed, from the aspect model selected by the user (step S303). Then, the view generation unit 102 performs the following steps S304 to S306 on the node conversion mapping selected in step S303.

In other words, the view generation unit 102 extracts all structures t, which match the conversion structure (the structure on the left side of the arrow of the node conversion mapping) of the node conversion mapping selected in step S303, from the requirement data t_{ALL} input in step S301. Then, the view generation unit 102 generates a node Cₜ corresponding to each of all the extracted structures t, and adds the generated node Cₜ to the view v (step S304). For example, when the structure t matches the conversion structure on the left side of the arrow of any node conversion mapping, a node on the right side of the arrow of such node conversion mapping is a node Cₜ corresponding to the structure t.

Next, the view generation unit 102 selects an entity e to be a target node from the entities e included in the structure t for each structure t that matches the conversion structure in step S304. Then, the view generation unit 102 adds the selected entity e to the mapping source column of the mapping table T (step S305).

Next, the view generation unit 102 adds the node Cₜ, which is generated in step S304, in the mapping destination column of the mapping table T and to the row of the entity e in the table, corresponding to the structure t including the entity e for each the entity e added to the mapping source column of the mapping table T in step S305 (step S306).

Next, the view generation unit 102 determines whether there is the node conversion mapping, on which steps S304 to S306 have not been performed, in the aspect model selected by the user (step S307). When there is the node conversion mapping on which steps S304 to S306 have not been performed (YES in step S307), the process returns to step S303.

On the other hand, when there is no node conversion mapping on which steps S304 to S306 have not been performed (NO in step S307), the view generation unit 102 selects one edge conversion mapping, on which the following steps S309 to S311 have not been performed, from the aspect model selected by the user (step S308). Then, the view generation unit 102 performs the following steps S309 to S311 on the edge conversion mapping selected in step S308.

In other words, the view generation unit 102 extracts all structures t, which match the conversion structure (the structure on the left side of the arrow of the edge conversion mapping) of the edge conversion mapping selected in step S308, from the requirement data t_{ALL} input in step S301. Then, the view generation unit 102 generates an edge

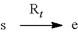

corresponding to each of all the extracted structures t, and adds the generated edge

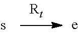

to the view v (step S309). For example, when the structure t matches the conversion structure on the left side of the arrow of any edge conversion mapping, an edge on the right side of the arrow of such edge conversion mapping is the edge

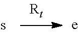

corresponding to the structure t.

Next, the view generation unit 102 adds the entity e included in the structure t for each structure t that matches the conversion structure in step S309 to the mapping source column of the mapping table T (step S310).

Next, the view generation unit 102 adds the edge

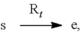

which 15 generated in step S304, in the mapping destination column of the mapping table T and to the row of the entity e in the table, corresponding to the structure t including the entity e for each the entity e added to the mapping source column of the mapping table Tin step S310 (step S311).

Next, the view generation unit 102 determines whether there is the edge conversion mapping, on which steps S309 to S311 have not been performed, in the aspect model selected by the user (step S312). When there is the edge conversion mapping on which steps S309 to S311 have not been performed (YES in step S312), the process returns to step S308.

On the other hand, when there is no edge conversion mapping on which steps S309 to S311 have not been performed (NO in step S312), the view generation unit 102 decides the view v and the mapping table T, and outputs the decided view v to the terminal 900, as a pre-update view v₀ (step S313).

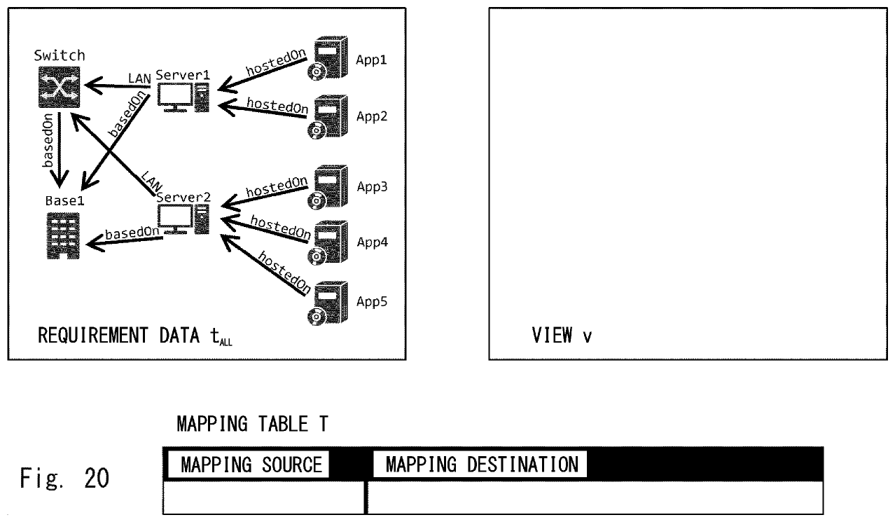

Subsequently, a concrete example of the forward conversion operations shown in FIGS. 18 and 19 will be described with reference to FIGS. 20 to 25.

First, a concrete example of the operations of steps S301 and S302 shown in FIG. 18 will be described with reference to FIG. 20.

In step S301, the view generation unit 102 inputs requirement data t_{ALL} as shown in, for example, FIG. 20 from the requirement data management unit 101.

Further, in step S302, the view generation unit 102 generates an empty view v and an empty mapping table T as shown in FIG. 20.

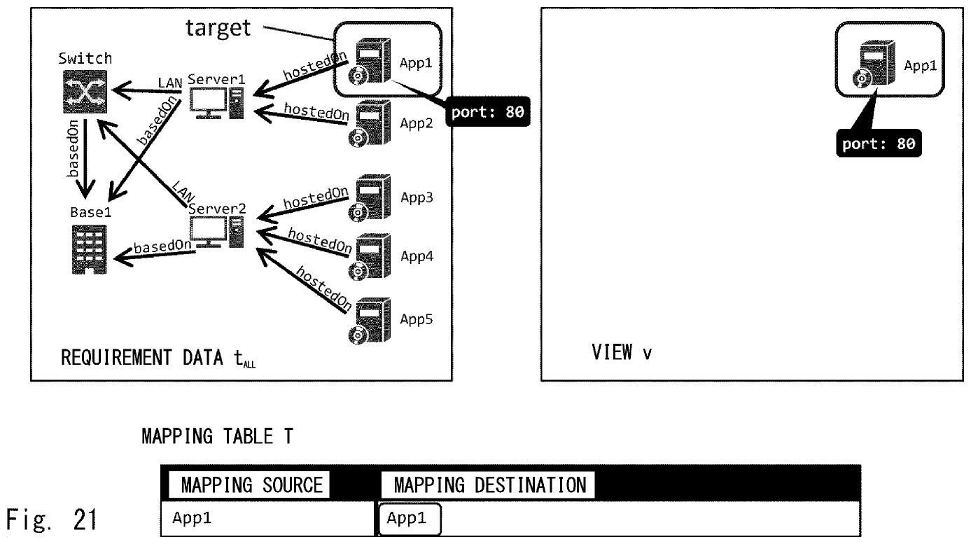

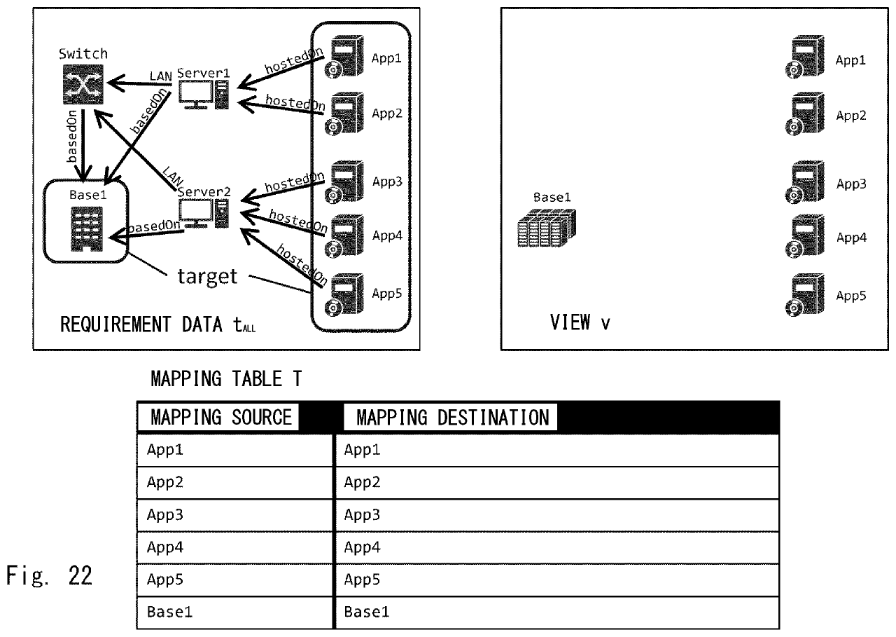

Next, a concrete example of operations of steps S303 to S306 shown in FIG. 18 will be described with reference to FIGS. 21 and 22.

In step S303, the view generation unit 102 selects one node conversion mapping, on which steps S304 to S306 have not been performed, from the aspect model selected by the user. In the example of FIG. 21, a node “App1” in the requirement data t_{ALL} matches the conversion structure of the node conversion mapping selected in step S303. The node “App1” in the requirement data t_{ALL} is the target node in the conversion structure of the node conversion mapping.

Therefore, the view generation unit 102 generates a node “App1” corresponding to the node “App1” in the requirement data t_{ALL} in step S304, and adds the generated node “App1” to the view v. At this time, the view generation unit 102 makes an ID of the node “App1” in the view v to be equal to an ID (here, “App1”) of the target node “App1” in the requirement data t_{ALL}. In addition, the view generation unit 102 sets a property (here, “port: 80”) of the node “App1” in the requirement data t_{ALL} to a property of the node “App1” in the view v, based on the property mapping information of the node conversion mapping.

Further, the view generation unit 102 adds, as an entity e, the target node “App1” in the requirement data t_{ALL} to the mapping source column of the mapping table T in step S305.

In addition, the view generation unit 102 adds the node “App1” in the view v corresponding to the node “App1” in the requirement data t_{ALL} in the mapping destination column of the mapping table T and to the same row as the entity e, which is the node “App1” in the requirement data t_{ALL}, in step S306.

FIG. 22 shows an example of the view v and the mapping table T after steps S304 to S306 are performed on all the node conversion mappings included in the aspect model.

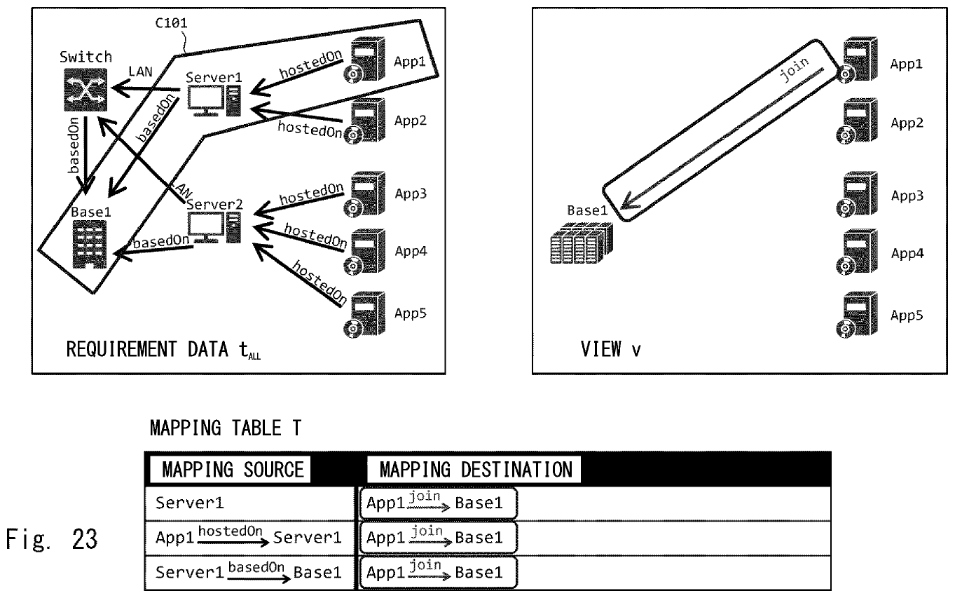

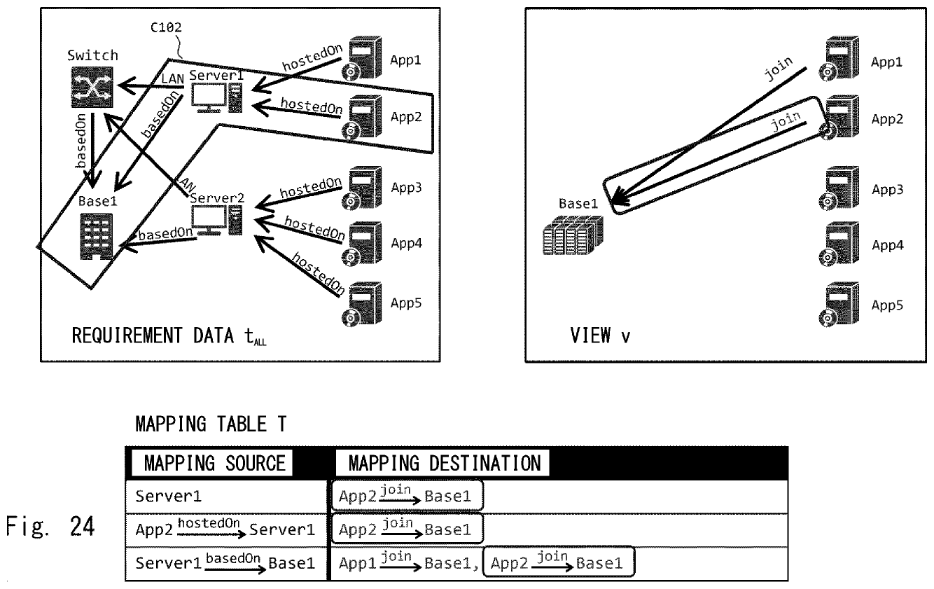

Next, a concrete example of the operations of steps S308 to S311 shown in FIG. 19 will be described with reference to FIGS. 23 and 24.

In step S308, the view generation unit 102 selects one edge conversion mapping, on which steps S309 to S311 have not been performed, from the aspect model selected by the user. In the example of FIG. 23, a structure C101 in the requirement data t_{ALL} matches the conversion structure of the edge conversion mapping selected in step S308.

In step S309, therefore, the view generation unit 102 generates an edge

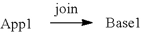

corresponding LU the structure C101 in the requirement data t_{ALL}, and adds the generated edge

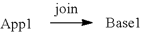

to the view v. At this time, when the edge conversion mapping has property mapping information, property processing is performed in the same manner as that described with reference to FIG. 21.

In step S310, the view generation unit 102 adds entities e included in the structure C101 in the requirement data t_{ALL} to the mapping source column of the mapping table T.

In step S311, the view generation unit 102 adds the edge

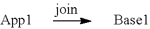

in the view v corresponding to each of the entities e included in the structure C101 in the requirement data t_{ALL} in the mapping destination column of the mapping table T and to the same row as each of the entities e included in the structure C101 in the requirement data t_{ALL}.

An example of FIG. 24 different from the example of FIG. 23 will be described. In the example of FIG. 24, a structure C102 in requirement data t_{ALL} matches the conversion structure of the edge conversion mapping selected in step S308.

In step S309, therefore, the view generation unit 102 generates an edge

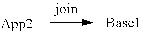

corresponding to the structure C102 in the requirement data t_{ALL}, and adds the generated edge

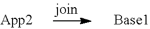

to the view v.

In step S310, the view generation unit 102 adds entities e included in the structure C102 in the requirement data t_{ALL} to the mapping source column of the mapping table T.

In step S311, the view generation unit 102 adds the edge

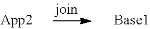

in the view v corresponding to each of the entities e included in the structure C102 in the mapping destination column of the mapping table T and to the same row as each of the entities e included in the structure C102 in the requirement data t_{ALL}.

In the mapping table T shown in FIG. 24, the edge

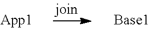

of the mapping destination of the entity

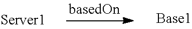

included in the structure C102 in the requirement data t_{ALL} has already been added.

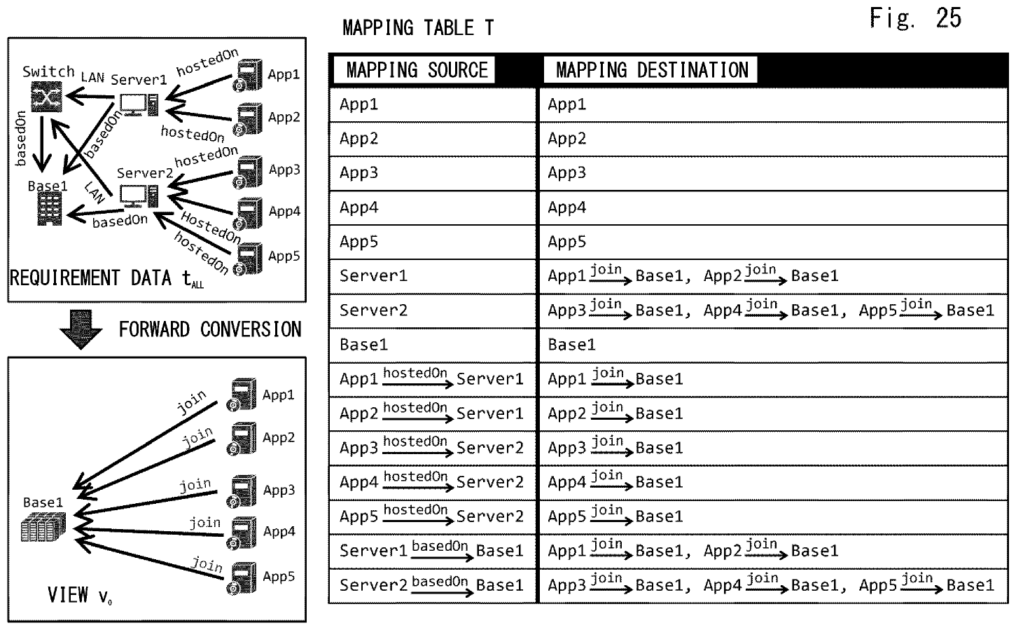

FIG. 25 shows an example of a view v and a mapping table T after the forward conversion operation shown in FIGS. 18 and 19 is completed. The view v shown in FIG. 25 is output to the terminal 900 as a pre-update view v₀.

### <Backward Conversion>

Subsequently, a conversion operation will be described in which the requirement data update unit 103 converts a view (post-update view) into requirement data. Hereinafter, such conversion is appropriately referred to as a backward conversion.

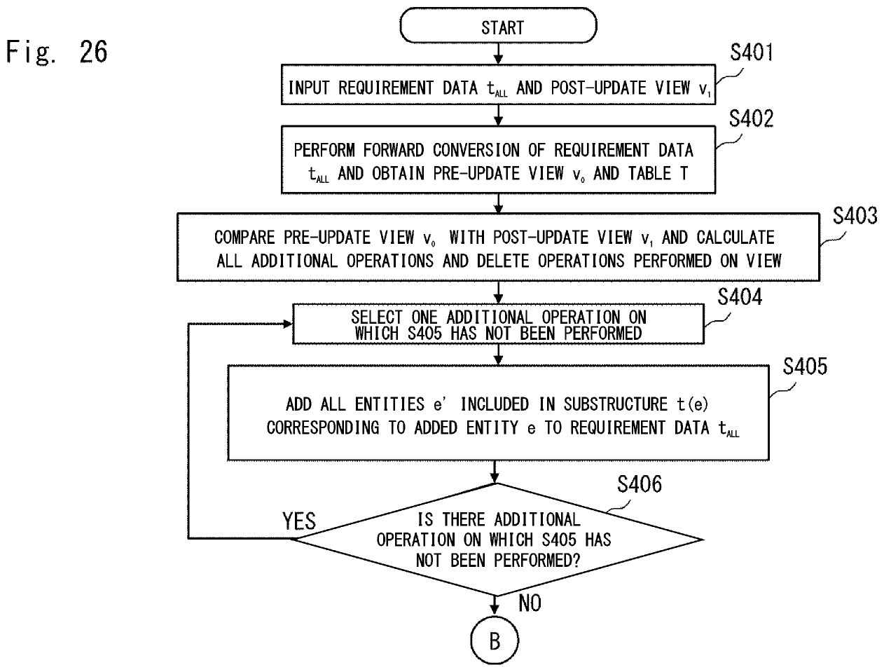

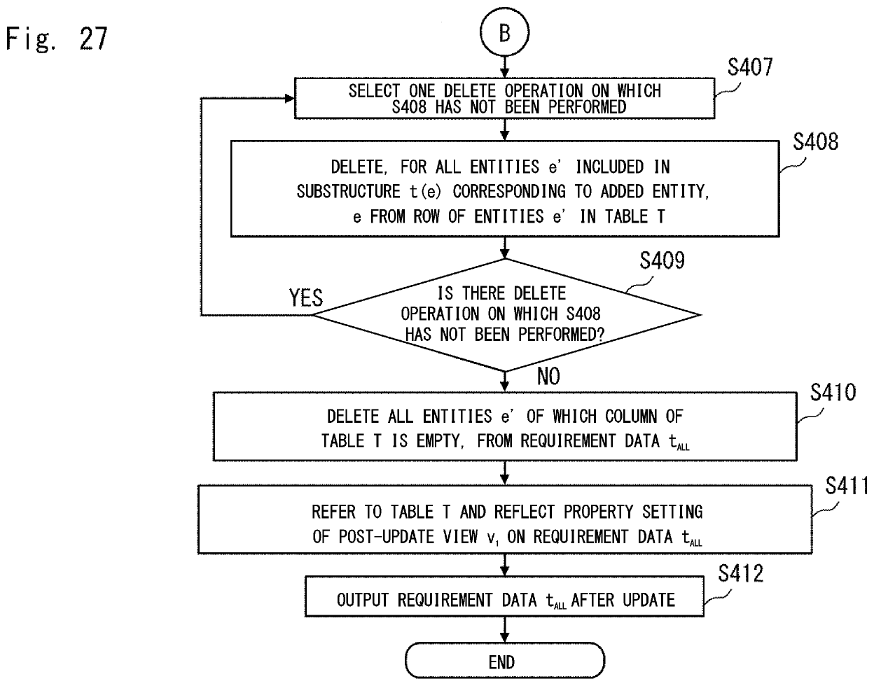

First, an example of a flow of a forward conversion operation by the requirement data update unit 103 will be described with reference to FIGS. 26 and 27.

As shown in FIGS. 26 and 27, first, the requirement data update unit 103 inputs a post-update view v₁ updated by the user from the terminal 900, and inputs requirement data t_{ALL} from the requirement data management unit 101 (step S401).

Next, the requirement data update unit 103 performs forward conversion of the requirement data t_{ALL}, and acquires a pre-update view v₀ and a mapping table T (step S402). The forward conversion of the requirement data t_{ALL} has already been performed by the view generation unit 102. Therefore, step S402 may be replaced with an operation of acquiring the pre-update view v₀ and the mapping table T from the view generation unit 102.

Next, the requirement data update unit 103 compares the pre-update view v₀ with the post-update view v₁, and calculates all additional operations (ADD e₁:t₁, ADD e₂:t₂, . . . ) and all delete operations (DEL e₁:t₁, DEL e₂:t₂, . . . ) performed on the pre-update view v₀ (step S403). The additional operation is an operation of adding the entity e to the pre-update view v₀, and the delete operation is an operation of deleting entity e to the pre-update view v₀.

Next, the requirement data update unit 103 selects one additional operation, on which the following step S405 has not been performed, from the additional operations calculated in step S403 (step S404). Then, the requirement data update unit 103 performs the following step S405 on the additional operation selected in step S404.

In other words, the requirement data update unit 103 adds all entities e′ included in a substructure t(e) corresponding to the entity e added by the additional operation selected in step S404 to the requirement data t_{ALL} (step S405). For example, when the entity e is the entity on the right side of the arrow in any mapping, a structure on the left side of the arrow in such mapping is a substructure t(e) corresponding to the entity e. In other words, when the entity e is the entity on the left side of the arrow in any structure generation pattern, a structure on the right side of the arrow in such a structure generation pattern is a substructure t(e) corresponding to the entity e.

Next, the requirement data update unit 103 determines whether there is an additional operation, on which step S405 has not been performed, among the additional operations calculated in step S403 (step S406). When there is the additional operation on which step S405 has not been performed (YES in step S406), the process returns to step S404.

On the other hand, when there is no additional operation on which step S405 has not been performed (NO in step S406), the requirement data update unit 103 selects one delete operation, on which the following step S408 has not been performed, from the delete operations calculated in step S403 (step S407). Then, the requirement data update unit 103 performs the following step S408 on the delete operation selected in step S407.

In other words, the requirement data update unit 103 confirms all entities e′ included in the substructure t(e) corresponding to the entity e, which is deleted by the delete operation selected in step S407, in the mapping source column of the mapping table T. For example, when the entity e is the entity on the right side of the arrow in any mapping, a structure on the left side of the arrow in such mapping is a substructure t(e) corresponding to the entity e. In other words, when the entity e is the entity on the left side of the arrow in any structure generation pattern, a structure on the right side of the arrow in such a structure generation pattern is a substructure t(e) corresponding to the entity e. Then, the requirement data update unit 103 deletes, for each of all the confirmed entities e′, the entity e in the mapping destination column of the mapping table T and from the row of the entity e′ in the table (step S408).

Next, the requirement data update unit 103 determines whether there is a delete operation, on which step S408 has not been performed, among the delete operations calculated in step S403 (step S409). When there is the delete operation on which step S408 has not been performed (YES in step S409), the process returns to step S407.

On the other hand, when there is no delete operation on which step S408 has not been performed (NO in step S409), the requirement data update unit 103 confirms entities e′ of which the mapping destination column of the mapping table T is empty. Then, the requirement data update unit 103 deletes all the confirmed entities e′ from the requirement data t_{ALL} (step S410).

Next, the requirement data update unit 103 refers to the mapping table T, and reflects property setting of the post-update view v₁ on the requirement data t_{ALL} (step S411).

Thereafter, the view generation unit 102 decides the requirement data t_{ALL}, and outputs the decided requirement data t_{ALL} to the requirement data management unit 101, as updated requirement data t_{ALL} (step 412).

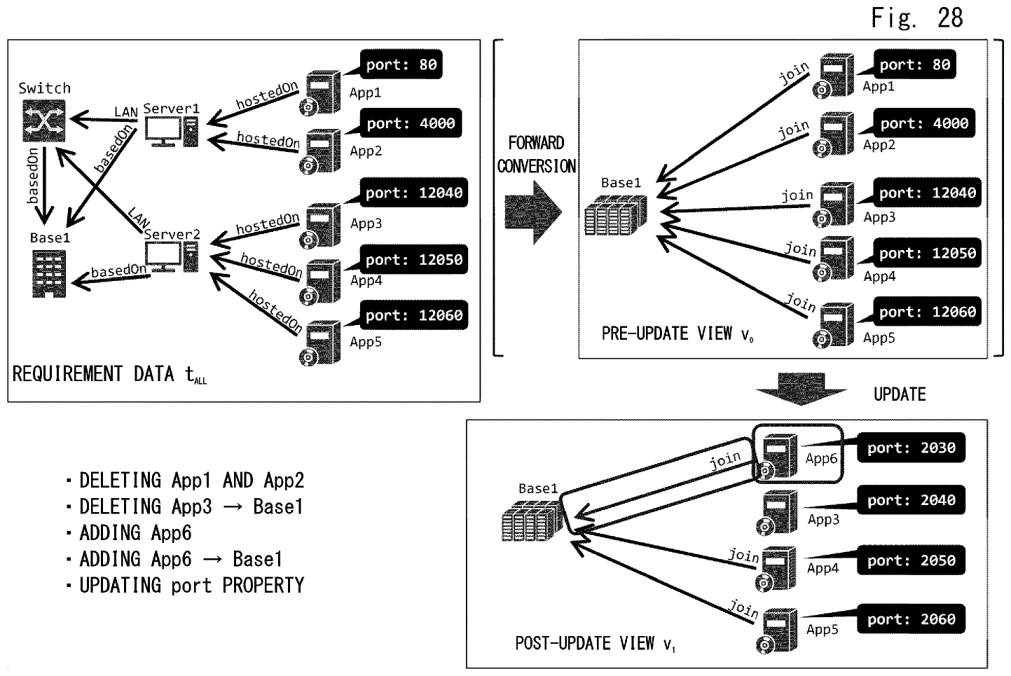

Subsequently, a concrete example of the backward conversion operation shown in FIGS. 26 and 27 will be described with reference to FIGS. 28 to 37.

First, a concrete example of the operation step S401 shown in FIG. 26 will be described with reference to FIG. 28.

In step S401, the requirement data update unit 103 inputs requirement data t_{ALL} as shown in, for example, FIG. 28 from the requirement data management unit 101.

Further, the requirement data update unit 103 inputs a post-update view v₁ as shown in, for example, FIG. 28 from the terminal 900. In the post-update view v₁, the following operations are performed on a pre-update view v₀:
deleting node “App1” and “App2”;
deleting an edge

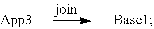

adding a node “App6”;
adding an edge

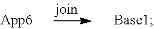

and
updating a port property.

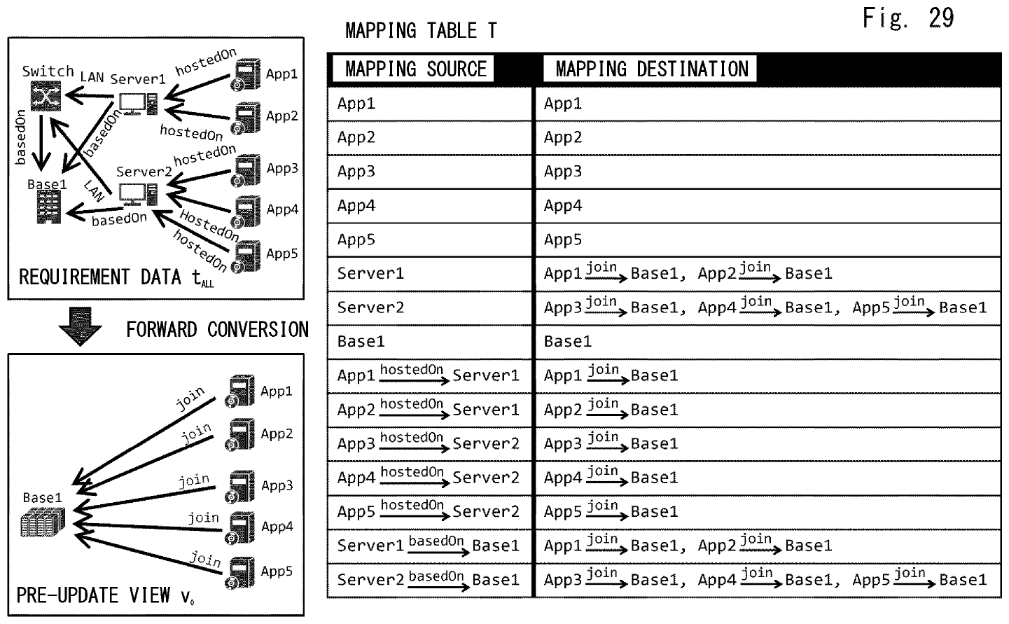

Next, a concrete example of the operation of step S402 shown in FIG. 26 will be described with reference to FIG. 29.

In step S402, the requirement data update unit 103 performs forward conversion of the requirement data t_{ALL}. As a result, the requirement data update unit 103 obtains a pre-update view v₀ and a mapping table T as shown in FIG. 29, for example.

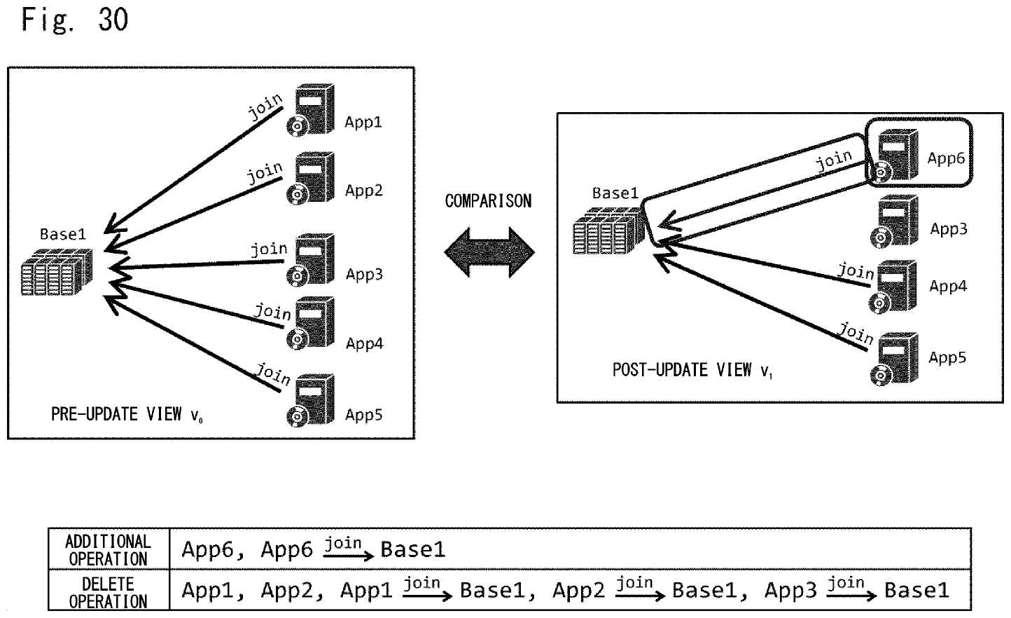

Next, a concrete example of the operation of step S403 shown in FIG. 26 will be described with reference to FIG. 30.

In step S403, the requirement data update unit 103 compares a pre-update view v₀ and a post-update view v₁ with each other as shown in FIG. 30, for example. Then, the requirement data update unit 103 calculates, based on the comparison result, all additional operations (ADD e₁:t₁, ADD e₂:t₂, . . . ) and all delete operations (DEL e₁:t₁, DEL e₂:t₂, . . . ) performed on the pre-update view v₀. As a result, the requirement data update unit 103 obtains an additional operation and a delete operation as shown in FIG. 30, for example.

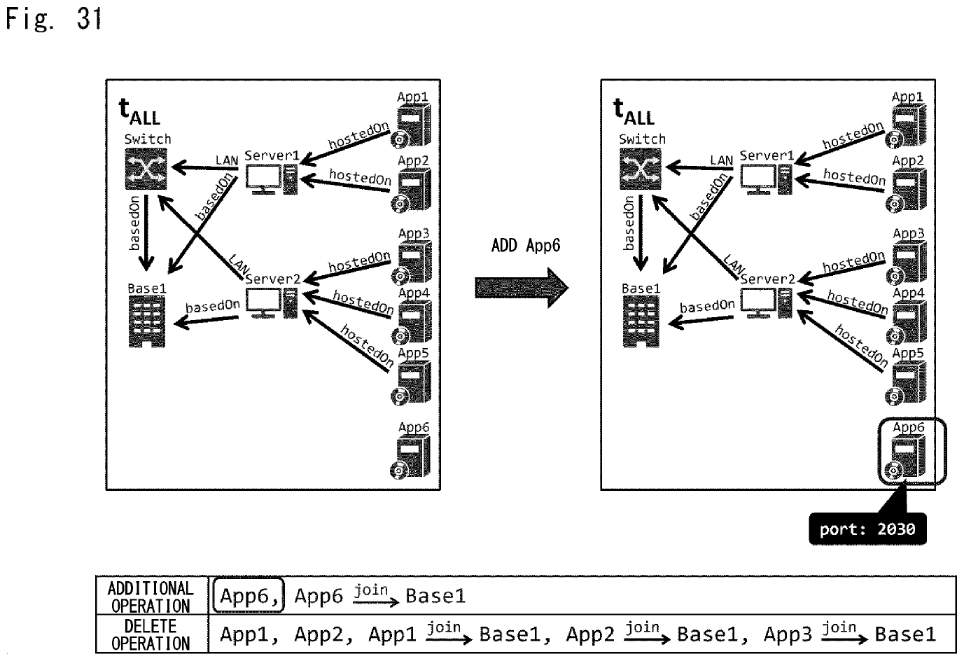

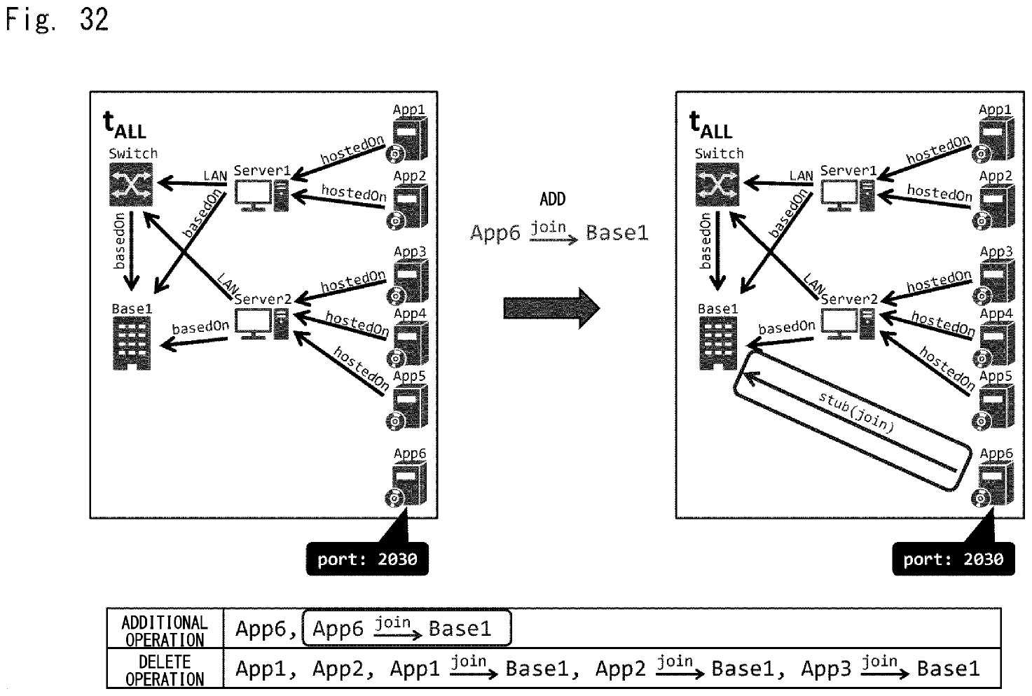

Next, a concrete example of the operations of steps S404 and S405 shown in FIG. 26 will be described with reference to FIGS. 31 and 32.

In step S404, the requirement data update unit 103 selects the additional operation, on which step S405 has not been performed, from the additional operations calculated in step S403. In the example of FIG. 31, the following additional operation is selected:
adding a node “App6”.

In this case, the requirement data update unit 103 adds the node “App6”, which is an entity e′ included in a substructure t(e) corresponding to the node “App6” to the requirement data t_{ALL} in the subsequent step S405.

At this time, the requirement data update unit 103 sets, based on property mapping information possessed by the mapping, a property (here, port: 2030) to the node “App6” added to the requirement data t_{ALL}.

Thereafter, it is assumed that the process returns to step S404 again. In this case, in step S404, the requirement data update unit 103 selects another additional operation, on which step S405 has not been performed, from the additional operations calculated in step S403. In the example of FIG. 32, the following additional operation is selected:
adding an edge

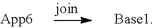

In this case, in the subsequent step S404, the requirement data update unit 103 adds an edge

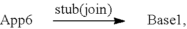

which is an entity e′ included in a substructure t(e) corresponding to the edge

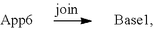

to the requirement data t_{ALL}.

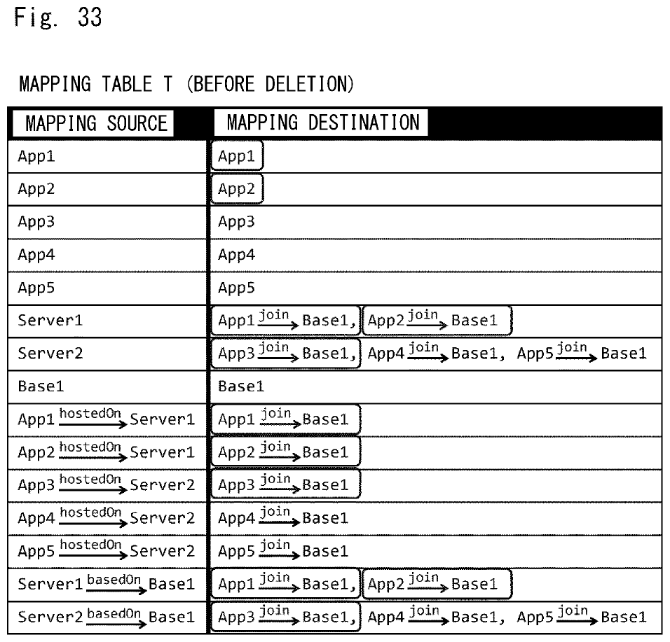

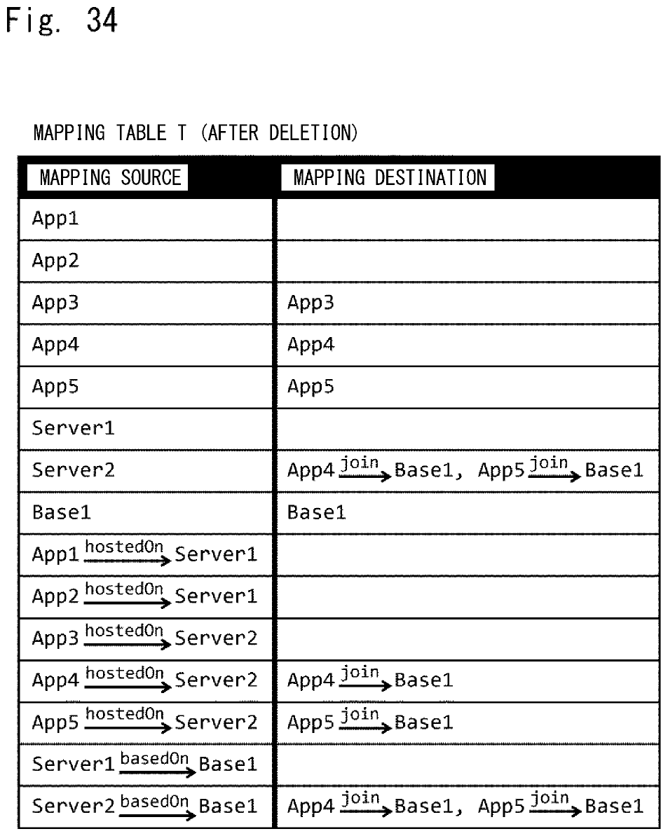

Next, a concrete example of the operations of steps S407 and S408 shown in FIG. 27 will be described with reference to FIGS. 33 and 34.

In step S407, the requirement data update unit 103 selects one delete operation, on which step S408 has not been performed, from the delete operations calculated in step S403.

In step S408, the requirement data update unit 103 confirms all entities e′ included in the substructure t(e) corresponding to the entity e, which is deleted by the delete operation selected in step S407, in the mapping source column of the mapping table T. Then, the requirement data update unit 103 deletes the entity e in the mapping destination column of the mapping table T and from the row of the entity e′ in the table for each of all the confirmed entities e′.

FIG. 34 shows an example of a mapping table T after step S408 is performed on all of the delete operations calculated in step S403, that is, after all the relevant entities e are deleted, and FIG. 33 shows an example of a mapping table T before all the relevant entities e are deleted.

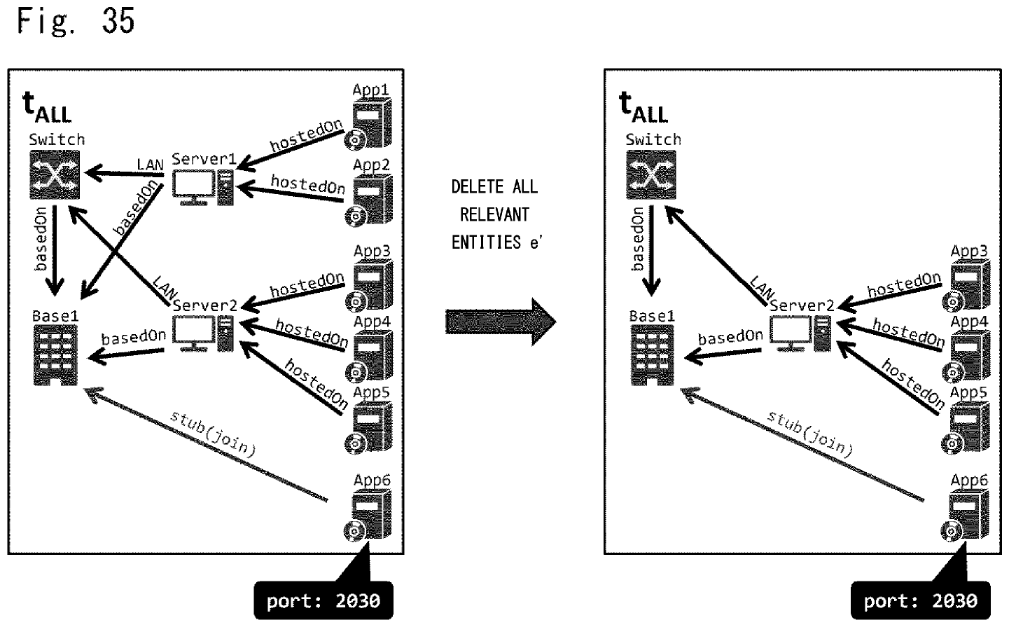

Next, a concrete example of the operation of step S410 shown in FIG. 27 will be described with reference to FIGS. 34 and 35.

In step S410, the requirement data update unit 103 confirms entities e′ of which the mapping destination column of the mapping table T is empty.

For example, in the example of FIG. 34, there are the following entities e′ of which the mapping destination column of the mapping table T is empty:
a node “App1”;
a node “App2”;
a node “Server1”;
an edge

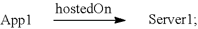

an edge

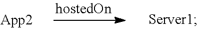

an edge

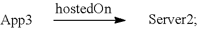

and
an edge

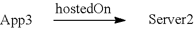

Therefore, the requirement data update unit 103 deletes all entities e′ of which the mapping destination column is empty as shown in FIG. 35, from the requirement data t_{ALL}.

In FIG. 35, the entity (edge)

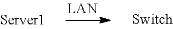

is deleted in conjunction with the deletion of the node.

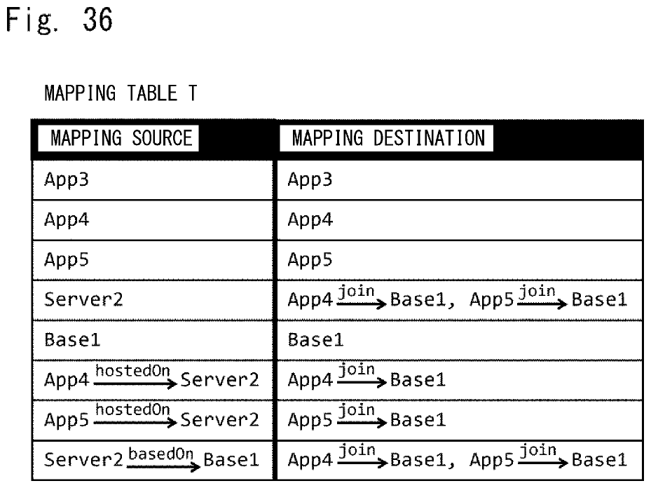

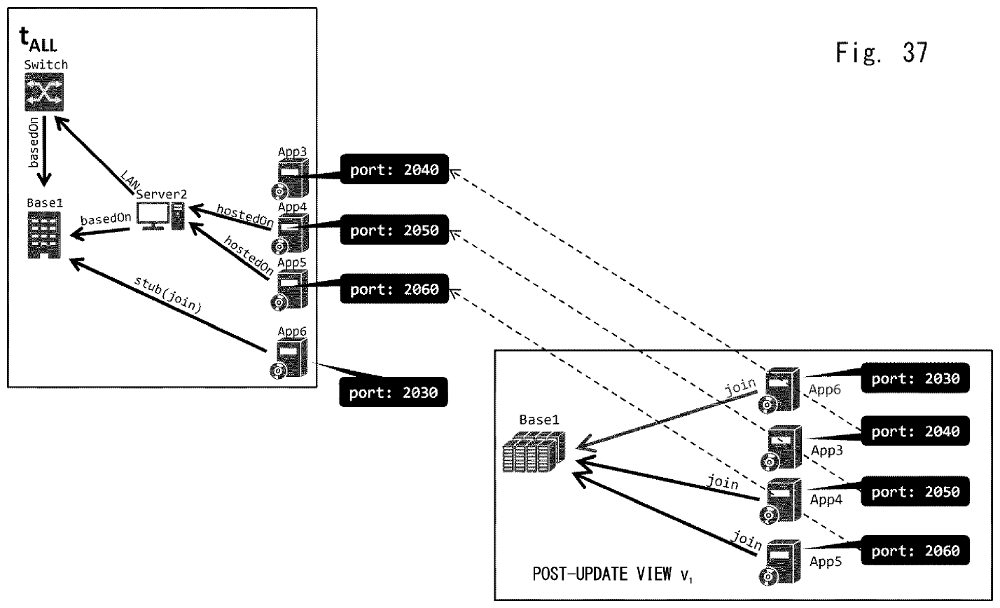

Next, a concrete example of the operation of step S411 shown in FIG. 27 will be described with reference to FIGS. 36 and 37.

In step S411, the requirement data update unit 103 refers to the mapping table T. When the entities e′ with the empty mapping destination column are deleted from the mapping table T shown in FIG. 34, the result is as shown in FIG. 36. The requirement data update unit 103 can determine which entity in the requirement data t_{ALL} corresponds to each of the entities in the post-update view v₁ with reference to the mapping table T shown in FIG. 36. Therefore, as shown in FIG. 37, the requirement data update unit 103 sets a property of the entity in the post-update view v₁ to a property of the corresponding entity in the requirement data t_{ALL}. In step S405 described with reference to FIG. 31, a property has already been set for the node “App6” in the requirement data t_{ALL}. Therefore, it is not necessary to perform the property setting in step S411 on the node “App6” in the requirement data t_{ALL}.

### <Effects of First Example Embodiment>

As described above, according to the first example embodiment, the requirement data is registered in the requirement data management unit 101, the requirement data being is a graph representing the system requirements. The view generation unit 102 inputs the requirement data, and also inputs the aspect model that is a model defining the conversion method of converting the requirement data into the graph in which alternative representation of the system requirements represented by the requirement data is given. Then, the view generation unit 102 generates the view that is a graph obtained by converting the requirement data using the aspect model, and outputs the generated view as a pre-update view. The requirement data update unit 103 inputs the requirement data, inputs the post-update view that is a view obtained after the pre-update view is updated, and reflects the content of the post-update view on the requirement data.

Therefore, the user can edit the system requirements by referencing and editing the view of the system requirements when viewed from a specific aspect. Thus, the user can easily edit the system requirements. As a result, it is possible to significantly reduce human costs necessary for the editing of the system requirements.

### Second Example Embodiment

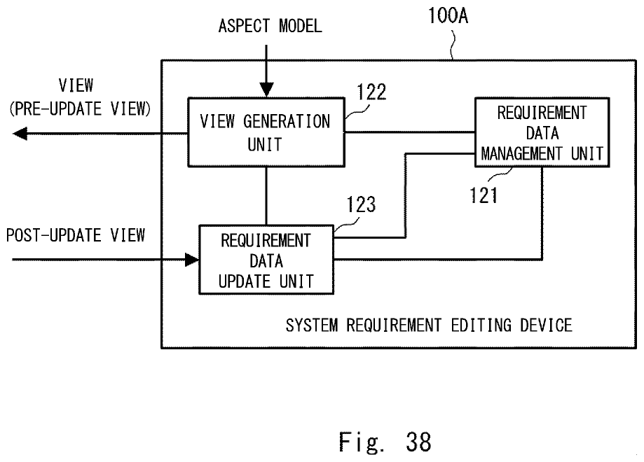

Subsequently, a description will be given with reference to FIG. 38 with respect to a configuration example of a system requirement editing device 100A according to a second example embodiment. As shown in FIG. 38, the system requirement editing device 100A according to the second example embodiment includes a requirement data management unit 121, a view generation unit 122, and a requirement data update unit 123.

Requirement data is registered the requirement data management unit 121, the requirement data being is a graph representing system requirements. The requirement data management unit 121 corresponds to the requirement data management unit 101.

The view generation unit 122 inputs the requirement data, and also inputs an aspect model that is a model defining a conversion method of converting the requirement data into a graph in which alternative representation of the system requirements represented by the requirement data is given. Then, the view generation unit 122 generates a view that is a graph obtained by converting the requirement data using the aspect model, and outputs the generated view as a pre-update view. The view generation unit 122 corresponds to the view generation unit 102.

The requirement data update unit 123 inputs the requirement data, inputs a post-update view that is a view obtained after the pre-update view is updated, and reflects the content of the post-update view on the requirement data. The requirement data update unit 123 corresponds to the requirement data update unit 103.

Therefore, the user can edit the system requirements by referencing and editing the view of the system requirements when viewed from a specific aspect. Thus, the user can easily edit the system requirements.

The requirement data update unit 123 may acquire the pre-update view and calculate an additional operation, which adds an entity, from operations performed on the pre-update view by comparing the pre-update view with the post-update view. Then, the requirement data update unit 123 may add an entity corresponding to the entity added to the pre-update view by the additional operation to the requirement data.

In addition, the requirement data update unit 123 may further acquire a mapping table that is a table in which entities in the requirement data are shown in a first column and entities in the pre-update view corresponding to the entities in the requirement data are shown in a second column of the same row. Further, the requirement data update unit 123 may calculate a delete operation of deleting entities from the operations performed on the pre-update view by comparing the pre-update view with the post-update view. Then, requirement data update unit 123 may delete the entities, which are deleted from the pre-update view by the delete operation, from the second column of the mapping table, and may delete an entity of which second column in the same row is empty among the entities shown in the first column, from the requirement data.

Further, the requirement data update unit 123 may set properties set for the entities in the post-update view to properties of the corresponding entities in the requirement data.

In addition, the view generation unit 122 may present the user with a list including at least one aspect model, and may input an aspect model selected by the user from the list of aspect models.

Further, the aspect model may be a model that defines a conversion method of converting a substructure in the requirement data into an entity.

Further, the requirement data may include a special entity which is a kind of entity not included in the original requirement data. In addition, the view generation unit 122 may input the aspect model, and output model data necessary for interpreting the meaning of the special entity.

### Third Example Embodiment

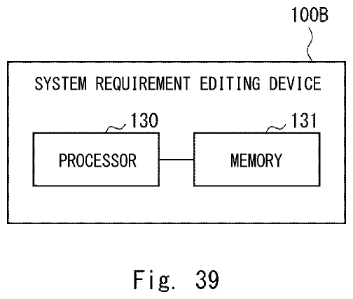

Subsequently, a description will be given with reference to FIG. 39 with respect to a hardware configuration example of a system requirement editing device 100B according to a third example embodiment. As shown in FIG. 39, the system requirement editing device 100B according to the third example embodiment includes a processor 130 and a memory 131.

The processor 130 may be, for example, a microprocessor, a micro processing unit (MPU), or a central processing unit (CPU). The processor 130 may include a plurality of processors.

The memory 131 is formed by a combination of a volatile memory and a nonvolatile memory. The memory 131 may include a storage located away from the processor 130. In this case, the processor 130 may access the memory 131 through an input/output interface (I/O interface, not shown).

The system requirement editing device 100 according to the first example embodiment and the system requirement editing device 100A according to the second example embodiment described above may have the hardware configuration shown in FIG. 39. The view generation unit 102 and the requirement data update unit 103 in the system requirement editing device 100 and the view generation unit 122 and the requirement data update unit 123 in the system requirement editing device 100A described above may be realized when the processor 130 reads and executes a program stored in the memory 131. In addition, the requirement data management unit 101 in the system requirement editing device 100 and the requirement data management unit 121 in the system requirement editing device 100A described above may be realized by the memory 131.

Further, the program described above includes a set of instructions (or software codes) for causing a computer to perform one or more functions described above in the example embodiments when being read into the computer. The program may be stored on a non-transitory computer-readable medium or a tangible storage medium. As an example, but not limited, the computer-readable medium or the tangible storage medium includes a random-access memory (RAM), a read-only memory (ROM), a flash memory, a solid-state drive (SSD) or other memory technologies, a CD-ROM, a digital versatile disc (DVD), a Blu-ray disc or other optical disc storages, a magnetic cassette, a magnetic tape, and a magnetic disc storage or other magnetic storage devices. The program may be transmitted on a transitory computer-readable medium or a communication medium. As an example, but not limited, the transitory computer-readable medium or the communication medium includes an electrical, optical, acoustic, or other forms of propagation signal.

Although the present disclosure is described above with reference to the example embodiments, the present disclosure is not limited to the above-described example embodiments. Various modifications that can be understood by those skilled in the art can be made to the configuration and details of the present disclosure within the scope of the present disclosure.

The first to third embodiments can be combined as desirable by one of ordinary skill in the art.

What is claimed is:

1. A system requirement editing device comprising:
a requirement data management unit in which requirement data is registered, the requirement data being a graph representing system requirements;
a view generation unit configured to input the requirement data, to input aspect models that are models defining a conversion method of converting the requirement data into a graph in which alternative representation of system requirements represented by the requirement data is given, to generate a view that is a graph obtained by converting the requirement data using the aspect models, and to output the generated view as a pre-update view; and
a requirement data update unit configured to input the requirement data, to input a post-update view that is a view obtained after the pre-update view is updated, and to reflect a content of the post-update view on the requirement data.

2. The system requirement editing device according to claim 1, wherein the requirement data update unit is configured to:
acquire the pre-update view,
calculate an additional operation, which adds an entity, from operations performed on the pre-update view by comparing the pre-update view with the post-update view, and
add an entity corresponding to the entity added to the pre-update view by the additional operation to the requirement data.

3. The system requirement editing device according to claim 2, wherein the requirement data update unit is configured to:
acquire a mapping table that is a table in which entities in the requirement data are shown in a first column and entities in the pre-update view corresponding to the entities in the requirement data are shown in a second column in the same row,
calculate a delete operation of deleting entities, from operations performed on the pre-update view by comparing the pre-update view with the post-update view,
delete the entities, which are deleted from the pre-update view by the delete operation, from the second column of the mapping table, and
delete an entity of which the second column in the same row is empty among the entities shown in the first column, from the requirement data.

4. The system requirement editing device according to claim 1, wherein the requirement data update unit is configured to set a property set for an entity in the post-update view to a property of a corresponding entity in the requirement data.

5. The system requirement editing device according to claim 1, wherein the view generation unit is configured to:
present a user with a list including at least one of the aspect models, and
input an aspect model selected by the user from the list of the aspect models.

6. The system requirement editing device according to claim 1, wherein each of the aspect models is a model that defines a conversion method of converting a substructure in the requirement data into an entity.

7. The system requirement editing device according to claim 1, wherein
the requirement data includes a special entity which is a kind of entity not included in original requirement data, and
the view generation unit is configured to input the aspect models, and to output model data necessary for interpreting a meaning of the special entity.

8. A system requirement editing method performed by the system requirement editing device, the method comprising:
a step of registering requirement data that is a graph representing system requirements;
a step of inputting the requirement data, inputting aspect models that are models defining a conversion method of converting the requirement data into a graph in which alternative representation of system requirements represented by the requirement data is given, generating a view that is a graph obtained by converting the requirement data using the aspect models, and outputting the generated view as a pre-update view; and
a step of inputting the requirement data, inputting a post-update view that is a view obtained after the pre-update view is updated, and reflecting a content of the post-update view on the requirement data.

9. A non-transitory computer-readable medium in which a program is stored, the program causing a computer to execute:
a procedure of registering requirement data that is a graph representing system requirements;
a procedure of inputting the requirement data, inputting aspect models that are models defining a conversion method of converting the requirement data into a graph in which alternative representation of system requirements represented by the requirement data is given, generating a view that is a graph obtained by converting the requirement data using the aspect models, and outputting the generated view as a pre-update view; and
a procedure of inputting the requirement data, inputting a post-update view that is a view obtained after the pre-update view is updated, and reflecting a content of the post-update view on the requirement data.
